(19) United States
(12) Patent Application Publication
(10) Pub. No.: US 2014/0115439 A1
(43) Pub. Date: Apr. 24, 2014

(54) METHODS AND SYSTEMS FOR ANNOTATING WEB PAGES AND MANAGING ANNOTATIONS AND ANNOTATED WEB PAGES

(71) Applicant: Scrible, Inc., San Mateo, CA (US)

(72) Inventors: Andrew Joseph Delpha, Dallas, TX (US); Victor Manu Karkar, Sunnyvale, CA (US)

(21) Appl. No.: 14/138,444

(22) Filed: Dec. 23, 2013

Related U.S. Application Data
(63) Continuation of application No. 13/168,641, filed on Jun. 24, 2011, now abandoned.
Application No. 13/168,641 is a continuation-in-part of application No. 12/954,411, filed on Nov. 24, 2010, now abandoned.
(60) Provisional application No. 61/358,273, filed on Jun. 24, 2010.
(60) Provisional application No. 61/264,217, filed on Nov. 24, 2009.
(60) Provisional application No. 61/345,711, filed on May 18, 2010.

(51) Int. Cl. G06F 17/24

(52) U.S. Cl. CPC G06F 17/241
USPC 715/230

(57) ABSTRACT

Methods and systems are provided for annotating content and managing annotated content, one or more annotations, and one or more web pages with the one or more annotations. The present invention provides a method that may include embedding a user interface in a web site. The user interface may include at least one annotation tool. Further, the method may include presenting the user interface with one or more web pages provided by the web site. The method may include allowing annotating content of the one or more web pages with one or more annotations. Further, the annotating may be allowed using the at least one annotation tool through the user interface. The method may also include managing at least one of the annotated content, the one or more annotations, and the one or more web pages with the one or more annotations.

### CROSS-REFERENCE TO RELATED APPLICATIONS

This application is a continuation of U.S. patent application Ser. No. 13/168,641, filed Jun. 24, 2011 which claims priority to U.S. Provisional Patent Application No. 61/358,273, filed Jun. 24, 2010.

U.S. patent application Ser. No. 13/168,641 U.S. patent application Ser. No. 13/168,641 is a continuation-in-part of now abandoned U.S. patent application Ser. No. 12/954,411, filed Nov. 24, 2010, which claims priority to U.S. Provisional Patent Application No. 61/264,217, filed Nov. 24, 2009 and U.S. Provisional Patent Application No. 61/345,711, filed May 18, 2010.

U.S. patent application Ser. No. 13/168,641 is a continuation-in-part of U.S. patent application Ser. No. 13/728,318, filed Dec. 27, 2012, which is a continuation of now abandoned U.S. patent application Ser. No. 12/484,556 (Pub. No. 2010/0017700), filed Jun. 15, 2009, which claimed priority to U.S. Provisional Patent Application No. 61/061,398, filed Jun. 13, 2008 and U.S. Provisional Patent Application No. 61/061,301, filed Jun. 13, 2008.

The entire disclosures of all the above applications are hereby incorporated herein by reference.

### GOVERNMENT FUNDING

This material is based upon work supported by the National Science Foundation under Award Number: SBIR Phase II Award 0958266.

### FIELD OF THE INVENTION

This invention relates to the field of information technology, and more particularly to methods for web page annotation and management of annotations and annotated web pages.

### BACKGROUND

Annotation of information is a valuable technique used in many fields, including publishing, research, law, and computer science, among many others. While tools exist for annotating documents and other items, there remains a need for methods and systems for customizing the annotation tools and management of the annotations and annotated documents.

### SUMMARY

In an aspect of the invention, a method may include allowing an annotation to an electronic document, optionally inputting the annotated electronic document to a recommendation engine, processing the annotated electronic document to extract at least one keyphrase, querying a data source with at least one of the annotation, the at least one keyphrase and the annotated electronic document, and presenting the result of the query, wherein the result is at least one of at least one recommended electronic document or no recommended electronic documents. Processing may include applying one or more filtering techniques. A weighting or a boosting may be applied to all or part of at least one of the annotation, the at least one keyphrase and the annotated electronic document. The data source may be at least one of a repository of electronic documents, a database of data or a repository of information. The data source may be at least one of remotely accessed (such as via an application programming interface (API)), locally accessed, remotely indexed, locally indexed, remotely stored or locally stored. An electronic document may be at least one of a web page, an HTML page, an HTML document, a Flash-based document, a Word document, a PowerPoint presentation, an Excel spreadsheet, a PDF, a word processing document, an OCR'ed document, a presentation, a spreadsheet, a text document, a rich text document, a Web document, an online document, a GOOGLE DOC, a GOOGLE Document, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include allowing an annotation to an electronic document, optionally inputting the annotated electronic document to a recommendation engine, processing the annotated electronic document to determine one or more topics of interest, querying a data source to identify electronic documents relevant to the one or more topics of interest, presenting the result of the query, wherein the result is at least one recommended electronic document or no recommended electronic documents. Processing may involve applying one or more techniques involving data or text mining, collaborative filtering, information extraction, computational linguistics, text parsing, lexical or semantic analysis, search, information retrieval (IR) or natural language processing (NLP). Inputting, processing or querying may include weighting or boosting of all or part of at least one of the annotation and the annotated electronic document. The data source may be at least one of a repository of electronic documents, a database of data or a repository of information. The data source may be at least one of remotely accessed (such as via an application programming interface (API)), locally accessed, remotely indexed, locally indexed, remotely stored or locally stored. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE Document, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include allowing an annotation to an electronic document, optionally inputting the annotated electronic document to a recommendation engine, querying a data source with the annotated electronic document, and presenting the result of the query, wherein the result is at least one of at least one recommended electronic document or no recommended electronic documents. Inputting or querying may include or be preceded by whole document modeling. Inputting or querying may include weighting or boosting the annotated electronic document. The data source may be at least one of a repository of electronic documents, a database of data or a repository of information. The data source may be at least one of remotely accessed (such as via an application programming interface (API)), locally accessed, remotely indexed, locally indexed, remotely stored or locally stored. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include allowing a user to make an annotation to an electronic document, optionally inputting the annotated electronic document to a recommendation engine, processing the annotated electronic document, querying a data source with at least one of the processed annotated electronic document and a result of the processing, and presenting at least one recommended electronic document or no recommended electronic documents based on a result of the query. Processing may include extracting at least one keyphrase. Processing may include filtering the keyphrase to remove an undesirable keyphrase or adjusting a weight of the keyphrase to obtain at least one weighted keyphrase.

In an aspect of the invention, a method may include allowing an annotation to an electronic document, optionally inputting the annotated electronic document to a recommendation engine, processing the annotated electronic document to extract at least one keyphrase, querying a shared repository of a plurality of electronic documents with at least one of the annotation, the at least one keyphrase and the annotated electronic document and presenting the result of the query, wherein the result is at least one of at least one recommended electronic document and no recommended electronic documents. Processing may involve applying one or more filtering techniques. Weighting or boosting is applied to all or part of at least one of the annotation, the at least one keyphrase and the annotated electronic document. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet. At least one of the plurality of electronic documents may be annotated.

In an aspect of the invention, a method may include allowing an annotation to an electronic document, optionally inputting the annotated electronic document to a recommendation engine, processing the annotated electronic document to determine one or more topics of interest, querying a shared repository of a plurality of electronic documents to identify electronic documents relevant to the one or more topics of interest, and presenting the result of the query, wherein the result is at least one of at least one recommended electronic document and no recommended electronic documents. Processing may include applying one or more techniques involving data or text mining, collaborative filtering, information extraction, computational linguistics, text parsing, lexical or semantic analysis, search, information retrieval (IR) or natural language processing (NLP). Inputting, processing or querying may include weighting or boosting of all or part of at least one of the annotation and the annotated electronic document. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet. At least one of the plurality of electronic documents may be annotated.

In an aspect of the invention, a method may include allowing an annotation to an electronic document, optionally inputting the annotated electronic document to a recommendation engine, querying a shared repository of a plurality of electronic documents with the annotated electronic document, and presenting the result of the query, wherein the result is at least one of at least one recommended electronic document and no recommended electronic documents. Inputting or querying may include or be preceded by whole document modeling. Inputting or querying may involve weighting or boosting of the annotated electronic document. The data source may be at least one of a repository of electronic documents, a database of data or a repository of information. The data source may be at least one of remotely accessed (such as via an application programming interface (API)), locally accessed, remotely indexed, locally indexed, remotely stored or locally stored. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet. At least one of the plurality of electronic documents may be annotated.

In an aspect of the invention, a method may include allowing a user to make an annotation to an electronic document, optionally inputting the annotated electronic document to a recommendation engine, processing the annotated electronic document, querying a shared repository of a plurality of electronic documents with at least one of the processed annotated electronic document and a result of the processing, and presenting at least one of at least one recommended electronic document and no recommended electronic documents based on a result of the query. Processing may include extracting at least one keyphrase. Processing may include filtering the keyphrase to remove an undesirable keyphrase or adjusting a weight of the keyphrase to obtain at least one weighted keyphrase. At least one of the plurality of electronic documents may be annotated.

In an aspect of the invention, a method may include allowing a first user to make an annotation to an electronic document, optionally inputting the annotated electronic document to a recommendation engine, optionally processing the annotated electronic document to extract at least one keyphrase, identifying a second user or group of users, wherein identifying is based on a similarity in at least one of a user profile, an interest, a preference, a like, a dislike, an information need, a social interest, an employer, a demographic, a geography, an occupation, a membership in an organization, a membership in a group, a membership in a social network group, a context, a relationship, a membership in a project, a membership in a project group, an access to a shared repository, an access to a shared resource, and a school or work relationship, querying a plurality of the second user's or group of users' electronic documents with at least one of the annotation, the keyphrase and the annotated electronic document, and presenting the result of the query, wherein the result is at least one of at least one recommended electronic document and no recommended electronic documents. At least one of the plurality of the second user's or group of users' electronic documents may be annotated. Processing may include applying one or more filtering techniques. Weighting or boosting may be applied to all or part of at least one of the annotation, the at least one keyphrase and the annotated electronic document. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include allowing a first user to make an annotation to an electronic document, optionally inputting the annotated electronic document to a recommendation engine, optionally processing the annotated electronic document to extract at least one keyphrase, identifying a second user by a similarity of the annotated electronic document with one of the second user's electronic documents or annotations, querying electronic documents associated with the second user with at least one of the annotation, the keyphrase, the annotated electronic document and the data associated with the annotated electronic document to identify at least one related electronic document, and presenting the result of the query as a recommendation.

The result of the query may include at least one related electronic document. The result of the query may indicate no related electronic documents. Weighting or boosting may be applied to all or part of at least one of the annotation, the at least one keyphrase and the annotated electronic document. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include allowing a first user to make an annotation to an electronic document, optionally inputting the annotated electronic document to a recommendation engine, optionally processing the annotated electronic document to extract at least one keyphrase, identifying a second user by a similarity of the annotation to the electronic document with an annotation to one of the second user's electronic documents or one of the second user's electronic documents, querying electronic documents associated with the second user with at least one of the annotation, the keyphrase and the annotated electronic document to identify at least one related electronic document, and presenting the result of the query as a recommendation. The result of the query may include at least one related electronic document. The result of the query may indicate no related electronic documents. Weighting or boosting may be applied to all or part of at least one of the annotation, the at least one keyphrase and the annotated electronic document. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include providing a user interface for allowing a user to make an annotation to an electronic document, wherein the user interface is part of at least one of a web browser; a web browser extension, plug-in, or add-on; a bookmark; a bookmarklet; a document creation, management or review system; a word processing, presentation or spreadsheet application; a mobile application, and a tablet computing application, optionally inputting the annotated electronic document to a recommendation engine, optionally processing the annotated electronic document to extract at least one keyphrase, querying a data source with at least one of the annotation, the at least one keyphrase and the annotated electronic document to identify at least one related electronic document, and presenting the related electronic document in the user interface as a recommendation. The recommendation may be presented dynamically, in real time, in real time as the user annotates, alongside the annotation, or presented in at least one of a sidebar of the user interface, a toolbar of the user interface, and a floating box of the user interface. The recommendation may be first cached. The recommendation may be presented at a later time. The recommendation may be presented when triggered by an action. The action may be at least one of an interaction with the annotated electronic document, mousing over an identifier of the annotated electronic document, and clicking on a link to the annotated electronic document. Processing may involve applying one or more filtering techniques. Weighting or boosting may be applied to all or part of at least one of the annotation, the at least one keyphrase and the annotated electronic document. The data source may be at least one of a repository of electronic documents, a database of data or a repository of information. The data source may be at least one of remotely accessed (such as via an application programming interface (API)), locally accessed, remotely indexed, locally indexed, remotely stored or locally stored. An electronic document is at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may include allowing an annotation to an electronic document, optionally inputting the annotated electronic document to a recommendation engine, extracting at least one keyphrase from at least one of the text of the annotation and the annotated electronic document, optionally filtering the at least one keyphrase to remove any undesirable extracted keyphrase, optionally adjusting a weight of the at least one keyphrase, utilizing the at least one keyphrase to formulate a query suitable for a search, querying a data source with at least one of the annotation, the at least one keyphrase and the annotated electronic document, and presenting the result of the query, wherein the result is at least one of at least one recommended electronic document and no recommended electronic documents. Weighting or boosting may be applied to all or part of at least one of the annotation, the at least one keyphrase and the annotated electronic document. The data source may be at least one of a repository of electronic documents, a database of data or a repository of information. The data source may be at least one of remotely accessed (such as via an application programming interface (API)), locally accessed, remotely indexed, locally indexed, remotely stored or locally stored. An electronic document may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

In an aspect of the invention, a method may be provided. The method may include embedding a user interface in a web site. The user interface may include at least one annotation tool. Further, embedding the user interface may include at least one of: embedding a code for the user interface, embedding a link to the user interface and embedding a button for the user interface. In embodiments the user interface is one of an annotation tool button, an annotation toolbar, a link to an additional portion of to the user interface, and a button for the user interface. Further, the user interface may be configured to be customized. The user interface may include customizing by at least one of including one or more annotation tools, branding the user interface and adjusting the color, size, layout and other design elements of the user interface. Further, customizing may include customizing by the website. Furthermore, the at least one annotation tool may include at least one of tools for highlighting, adding a note, changing text color, bolding, underlining, italicizing, striking through, undoing an annotation, redoing an annotation, showing all annotations, hiding all annotations, annotating with recorded voice, commenting, printing, reading annotations, stamping, boxing, clouding, drawing, circling, marking, and calling-out.

The method may further include presenting the user interface with one or more web pages provided by the website. Presenting of the user interface may include presenting the user interface to one or more authenticated viewers. The authenticated viewers may be authenticated by the website.

The method may include allowing annotation of content of the one or more web pages, with one or more annotations. The annotating may be allowed using the at least one annotation tool through the user interface. In an embodiment, the content may include at least one of an HTML content, an HTML document, Flash-based content, an object, an image, a PDF document, an online text document, an online presentation, an online spreadsheet, and the like. Further, annotated content is syndicated content and the web site may host syndicated content.

Furthermore, the method may include managing at least one of the annotated content, the one or more annotations, and the one or more web pages with the one or more annotations. The managing may include organizing at least one of the annotated content, the one or more annotations, and the one or more web pages with the one or more annotations. Further, the organizing includes using at least one of folders, tags, filters, search, tables, lists, sortable columns, date stamps, time stamps, indices, hierarchies, ontologies and data structures. The organizing may also include further annotating the at least one of the annotated content, the one or more annotations, and the one or more web pages with the one or more annotations.

In embodiments, the managing may further include saving the at least one of the annotated content, the one or more annotations, and the one or more web pages with the one or more annotations. The saving may include saving at a repository of the web site. The saving may further include saving to a cloud, a remote server or an online account or a repository. In another embodiment, the managing may include collaborating on the at least one of the annotated content, the one or more annotations, and the one or more web pages with the one or more annotations. Further, the managing may include sharing the at least one of the annotated content, the one or more annotations, and the one or more web pages with the one or more annotations. The method may further include recommending at least one web page related to the annotated content of the one or more web pages.

In another aspect of the invention, a method may be provided. The method may include providing a user interface for embedding in a web site. The user interface may include at least one annotation tool for annotating content of one or more web pages provided by the web site with one or more annotations. The user interface may be embedded in the form of one of an annotation tool button, an annotation toolbar, a link to an additional portion of to the user interface, and a button for the user interface. The method may further include providing a white-labeled version of the user interface.

Further, the method may include allowing customizing the user interface. Customizing the user interface may comprise customizing by at least one of including one or more annotation tools, branding the user interface and adjusting the color, size, layout and other design elements of the user interface. The method further includes customizing the white-labeled version of the user interface.

The method may further allow annotating content of the one or more web pages with one or more annotations, the annotating allowed using the at least one annotation tool through the user interface. The annotation tool may include at least one tool for highlighting, adding a note, changing text color, bolding, underlining, italicizing, striking through, undoing an annotation, redoing an annotation, showing all annotations, hiding all annotations, annotating with recorded voice, commenting, printing, reading annotations, stamping, boxing, clouding, drawing, circling, marking and calling-out. Further, annotated content is syndicated content and the web site may host syndicated content.

The method may also include managing at least one of the annotated content, the one or more annotations, and the one or more web pages with the one or more annotations. The managing may include organizing at least one of the annotated content, the one or more annotations, and the one or more web pages with the one or more annotations. The organizing may include organizing by allowing at least one of tags, filters, search, tables, lists, sortable columns, date stamps, time stamps, indices, hierarchies, ontologies and data structures. The organizing may also include further annotating the at least one of the annotated content, the one or more annotations, and the one or more web pages with the one or more annotations.

In embodiments, the managing may further include saving the at least one of the annotated content, the one or more annotations, and the one or more web pages with the one or more annotations. The saving may include saving at a repository of a provider of the user interface. The saving may further include saving to a cloud, a remote server or an online account or a repository. Further, the managing may include collaborating on the at least one of the annotated content, the one or more annotations, and the one or more web pages with the one or more annotations. The managing may also include sharing the at least one of the annotated content, the one or more annotations, and the one or more web pages with the one or more annotations. The method may further comprise recommending at least one web page related to the annotated content of the one or more web pages.

In another aspect of the invention, a computer program product embodied in a computer readable medium may be provided. The computer program product when executed on one or more computers may perform the steps embedding a user interface in a web site. The user interface may include at least one annotation tool. Further, the computer program product when executed on one or more computers performs the step of presenting the user interface with one or more web pages provided by the website. In an embodiment, the computer program product when executed on one or more computers performs the step of allowing annotation of content of the one or more web pages, with one or more annotations. The annotations may be allowed using the at least one annotation tool through the user interface. In addition, the computer program product when executed on one or more computers performs the step of managing at least one of the annotated content, the one or more annotations, and the one or more web pages may be managed with the one or more annotations.

In another aspect of the invention, a computer program product embodied in a computer readable medium may be provided. The computer program product when executed on one or more computers may perform the step of providing a user interface for embedding in a web site. The user interface may include at least one annotation tool for annotating content of one or more web pages provided by the web site with one or more annotations. Further, the computer program product when executed on one or more computers performs the step of allowing customizing the user interface. The computer program product when executed on one or more computers may further perform the step of allowing annotating content of the one or more web pages with one or more annotations, the annotating allowed using the at least one annotation tool through the user interface. In addition, the computer program product when executed on one or more computers performs the step of managing at least one of the annotated content, the one or more annotations, and the one or more web pages with the one or more annotations.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless such understanding conflicts with the context in which such references are used, unless such understanding hinders the system and methods disclosed herein, or unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a Toolbar of the content recommendation system with associated highlight and note annotations.

FIG. 2 depicts Recommendations presented in real-time via a (Suggestions Box) UI as a user annotates.

FIG. 3 depicts Pre-generated and cached recommendations presented next to a user's Personal Archive via a (Suggestions Box) UI.

FIG. 4 depicts a Recommendation title and snippet and related features.

FIG. 5 depicts binary scoring control in a (Suggestions Box) recommendation presentation UI.

FIG. 6 depicts a method of content recommendation.

FIG. 7 depicts a method of keyphrase processing.

FIG. 8 depicts a process flow for recommendation generation.

FIG. 9 depicts a process flow for keyphrase handling.

FIG. 10 depicts a process flow for a recommendation system.

FIG. 11 depicts a process flow for a real-time recommendation system.

FIG. 12 depicts a process flow for a social recommendation system.

FIG. 13 depicts a system for embedding a user interface for web page annotation and managing annotations and annotated web pages and content.

FIG. 14 depicts a method for embedding a user interface in a web site.

FIG. 15 depicts an exemplary user interface.

FIG. 16 depicts an exemplary web site with a user interface embedded in a web page.

FIG. 17 depicts an exemplary web page of an exemplary web site for managing annotated content.

FIG. 18 depicts a method for annotating and managing web pages in connection with a user interface embedded in a web site, in accordance with an embodiment of the present invention.

FIG. 19 depicts a method for annotating and managing web pages in connection with a user interface embedded in a web site, in accordance with another embodiment of the present invention.

FIG. 20 depicts an exemplary method for customizing and embedding a user interface.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

In an aspect of the invention, an intelligent content recommendation system may be based on personal online research annotations and may be used in generating recommendations based on annotations, annotated electronic documents, or keyphrases therein. The content recommendation system may be built on or integrated with any methods or systems for electronic document annotation such as, for example, the annotation system described in U.S. patent application Ser. No. 12/484,556, which is hereby incorporated by reference. For example, users may employ digital annotation tools, such as highlighters and sticky notes, to mark up electronic documents. The Recommendation System may leverage these annotations to accurately model users' information needs and suggest highly relevant recommendations. This may be achieved by creatively applying information retrieval (IR), natural language processing (NLP) and other techniques, and by using one or more of the annotation, the entire annotated electronic document, or keyphrases extracted from the annotated electronic document as inputs to a recommendation engine. The electronic documents, which may be any of the annotated electronic documents, queried electronic documents, recommended electronic documents, or the like, may include one or more of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet. In the Recommendation System, annotations may be effectively leveraged to focus the topic scope of recommendations and thereby increase their relevance to users' information needs. Annotations may be leveraged to make relevant “social” recommendations between users with shared information needs by enabling the Recommendation System to use a Shared Archive of electronic documents as a repository from which such recommendations can be made. The Recommendation System may enable integrating recommendations directly into the research process with user acceptance by implementing and refining user interfaces that may present recommendations to users during the course of their natural reading and research activities. Also, in comparison to a Boolean retrieval model, a language model approach to recommending documents may yield gains in relevance quality and may be employed.

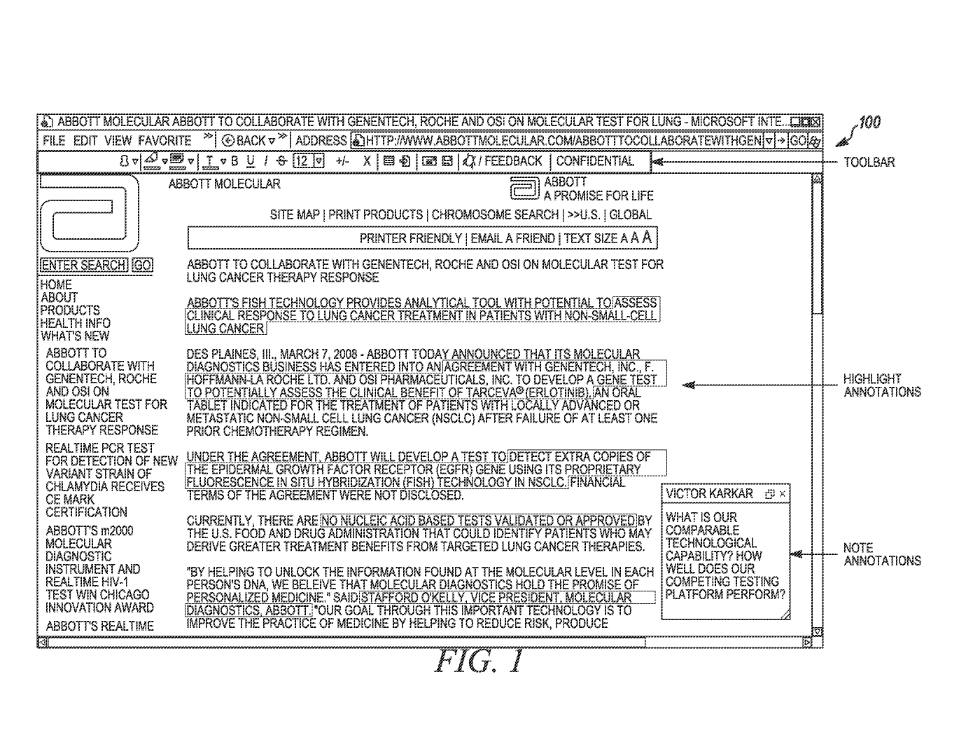

An electronic document annotation and management platform (Platform) may include a Toolbar, plug-in, add-on, extension, widget or app; an Internet browser plug-in, add-on, extension, or bookmarklet; or JavaScript-based toolbar or the like, that may allow a user to mark up an electronic document with annotations such as highlights and sticky notes (FIG. 1). The Toolbar may allow the user to—among other things—save an annotated electronic document to a personal online account. The Platform may also include a web site, where a user may sign into their account to view, search, retrieve, organize and collaborate on their saved, annotated electronic documents. The web site may allow a user to organize their electronic documents in a Personal Archive with tagging and search capabilities. Users in organizations such as companies may have access to a similar organization-wide Shared Archive. Users may use Shared Archives to collaborate on electronic documents of mutual interest. The Platform, as well as additional related functionality not detailed here, may also serve as a Web document or web page annotation and online research management platform.

The Recommendation System (System) may process annotated electronic documents of interest and recommend related, relevant electronic documents to users from a variety of data sources via at least one user interface (UI). Annotations may be made using the Platform or any other annotation system or method. The data sources from which recommendations may be made include, but are not limited to, locally indexed repositories, third party collections, and any publicly or privately accessible data source accessed via an application programming interface (API), and may include content from any one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet. In an aspect of the invention, a Suggestion Framework may include multiple software modules that process the annotated electronic documents to generate queries, run those queries against one or more data sources and return recommendations, or an indication of no recommendation. The Suggestion Framework may leverage a number of third party tools and technologies. In an aspect of the invention, specific feedback mechanisms may be built into the Recommendation System to enable evaluation of the System and its UIs as they may be experienced by users.

In embodiments, a Recommendation System may present a recommendation to users via one or more UIs. In an embodiment of a UI, a recommendation may be dynamically generated, refreshed and presented to a user in real time while they annotate an electronic document of interest. In an embodiment, the recommendation may be presented in a Suggestions Box that may be displayed as an overlay over the electronic document. The Suggestions Box may be a frame, an iframe, a div, a box, a layer, a section, and the like and may appear to float over the electronic document. As the user may navigate around the electronic document, the Suggestions Box may remain in the user's view. The Suggestions Box may automatically change its size and appearance, and may be manually resizable, movable, minimizable, dismissible and the like.

In another embodiment of the UI, the Suggestions Box may be displayed as a window, box, palette, toolbar, sidebar or the like in an Internet browser application; a Flash-based document management, editing or reading application; MICROSOFT WORD, POWERPOINT or EXCEL; a PDF creation, editing, reading or management application such as ADOBE ACROBAT or ADOBE ACROBAT READER; a word processing application; a document management or review application or system; an online document, presentation, or spreadsheet application or service such as GOOGLE DOCS or ZOHO DOCS and the like; a research or information service application such as offered by LEXISNEXIS, WESTLAW, THOMSON REUTERS, BLOOMBERG and the like; a mobile application; a tablet computing application; a touchscreen application; and the like.

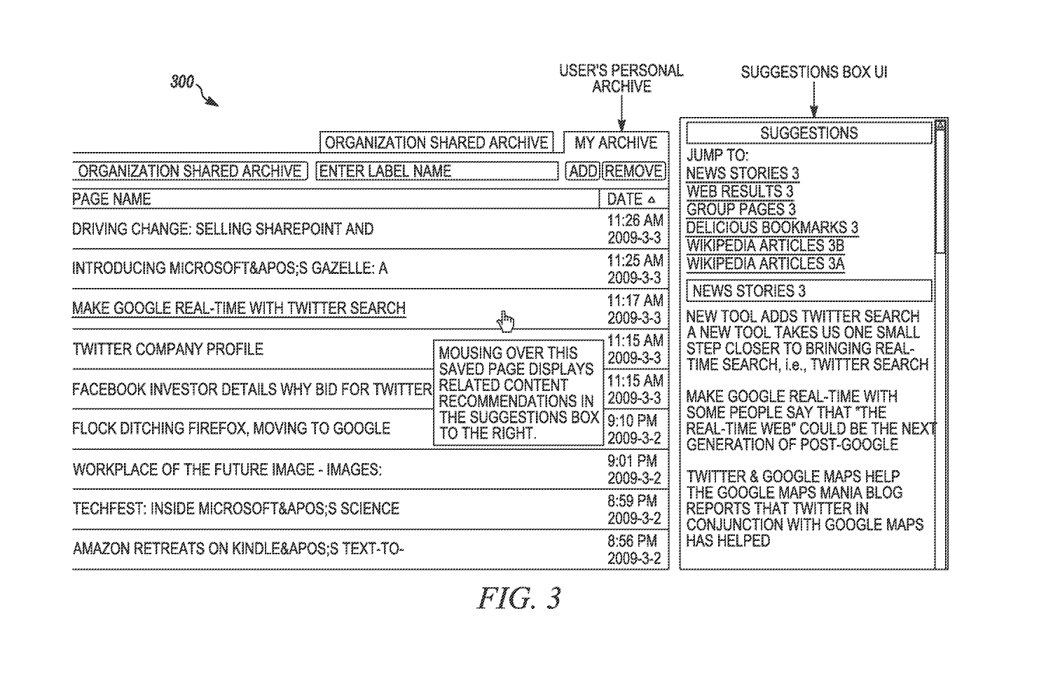

In another embodiment of the UI, a recommendation for an annotated electronic document may be pre-generated and cached or saved on a tangible media, such as a hard drive, a server, and the like. The cached recommendation may be displayed in a Suggestions Box, which may be shown along with the user's Personal Archive. As the user navigates through the Personal Archive, the Suggestions Box may be dynamically updated to provide a cached recommendation related to the annotated electronic document being hovered, moused over, selected, highlighted, clicked or the like in the Personal Archive (FIG. 3). In an embodiment, the user may use a pointing device, such as a mouse, a track pad, a stylus, and the like to mouse over an annotated electronic document or its identifier or a link to it within the Personal Archive. In another embodiment, the user may use a finger to tap the touch screen of a mobile or tablet computing device to hover, mouse over, select, highlight or click on an annotated electronic document or its identifier or a link to it within the Personal Archive. The Suggestions Box may be dynamically updated with a recommendation related to the annotated electronic document being hovered, moused over, selected, highlighted, clicked or the like, which may help the user confirm that the recommendation is related to that annotated electronic document. In another embodiment, the Suggestions Box may be shown along with a Shared Archive.

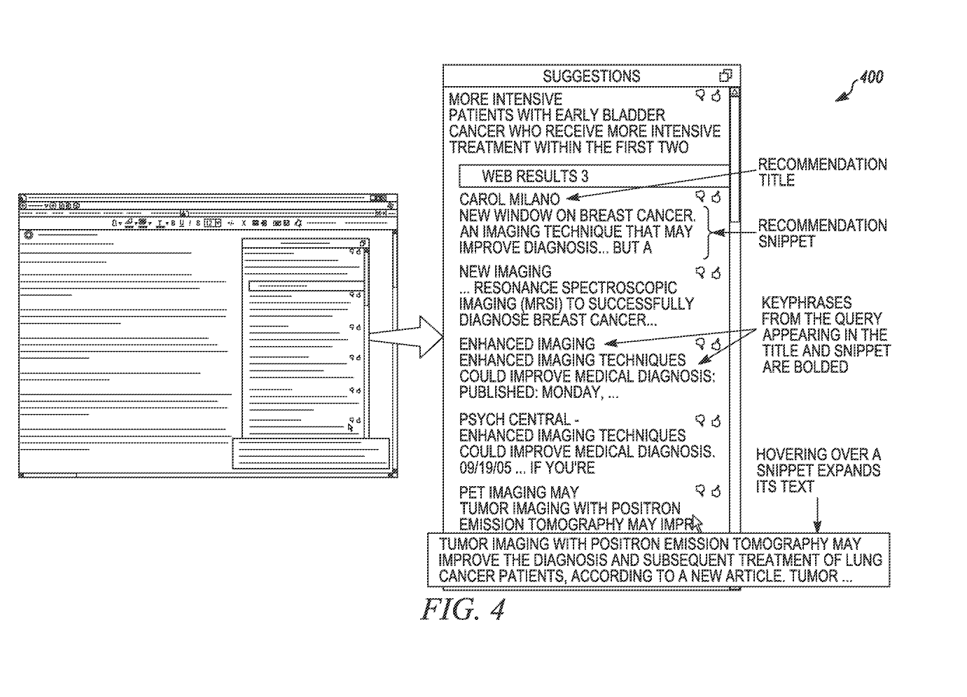

In an embodiment, the Suggestions Box may contain a recommendation that may consist of a title and snippet (FIG. 4). The title may be text, and may be a clickable hyperlink to a recommended electronic document. The snippet may consist of text, image, and the like, and may provide a brief description of the recommended electronic document. In an embodiment, navigating to, selecting, clicking, mousing over or hovering the title or snippet may expand the title or snippet to provide more information about the recommended electronic document. The expanded information may be presented as additional information in the snippet, a mouse pointer tool tip, and the like. In an embodiment, the title and snippet may contain information dependent on the data source from which they are obtained. As an example, and not a limitation, a WIKIPEDIA recommendation may result in the title being the title of the WIKIPEDIA article and the snippet being the first sentence of the article. As another example, a web page recommendation may result in the title being the page title and the snippet being a description of the web page returned by a search engine (such as YAHOO!, GOOGLE, or BING), a data source, a web service, an information service provider or the like with a hyperlink to the recommended electronic document.

In an embodiment, the recommendation in the Suggestion Box may contain a keyphrase that appears in the query for that recommendation. The keyphrase may be displayed in a manner that sets it visually apart from the rest of the recommendation text, such as by highlighting, bolding, underlining, and the like. Such a visual cue may help the user quickly identify the keyphrase driving the recommendation, see the keyphrase in the context of the text of the recommended electronic document and quickly judge the relevance of the recommendation. This is similar to the bolding of search terms in Internet search engine search results.

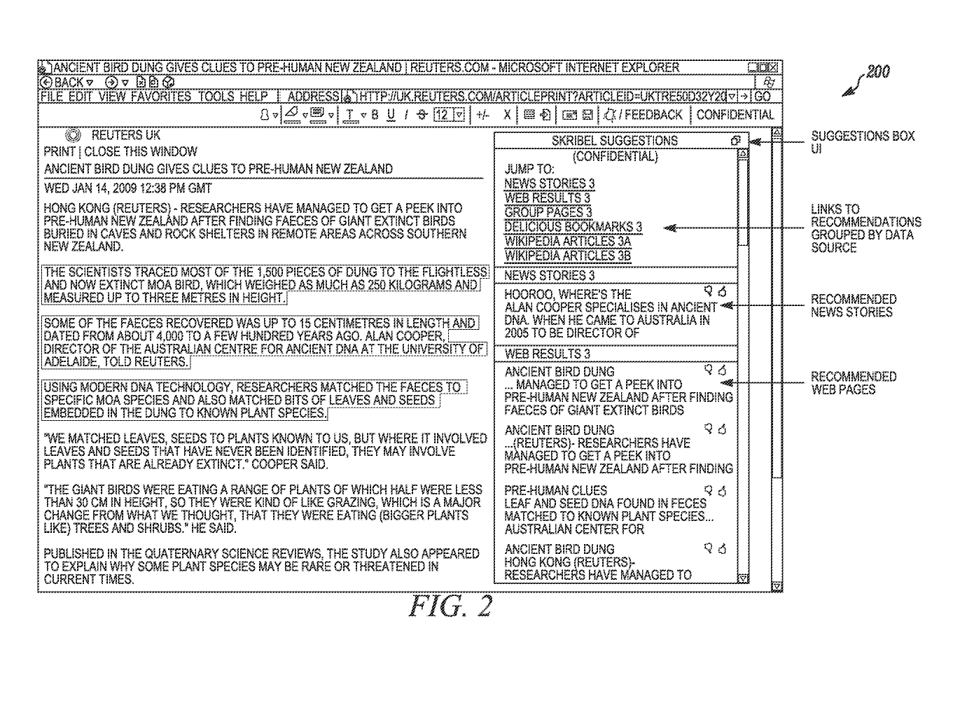

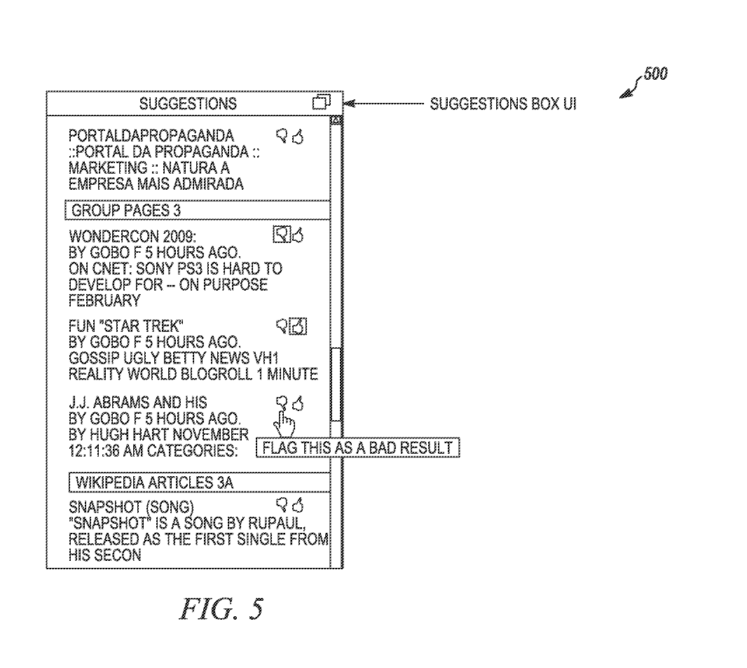

In an embodiment, and referring to FIG. 2, the Suggestions Box may contain a plurality of recommendation groups. A recommendation group may consist of a plurality of recommendations that may be grouped together. The recommendations may be grouped by their data source. Further in the embodiment, a hyperlink to a particular recommendation group may be presented in the Suggestions Box. A user may select or click on the hyperlink to have the recommendation group come into view (FIG. 3). Alternatively, the user may scroll or navigate through all of the recommendations in the Suggestions Box (FIG. 4, FIG. 5).

In an embodiment, a Shared Archive that contains saved electronic documents may be used as a data source for recommendations. The Shared Archive may be used to share electronic documents among users grouped by interests, preferences, likes, dislikes, information needs, social interests, employer, demographics, geography, occupation, membership in an organization, membership in a group, a membership in a project, a membership in a project group, an access to a shared repository, an access to a shared resource, membership in a social networking group, context, relationship, school, work and the like. A user may annotate an electronic document; a related annotated or unannotated electronic document previously stored in the Shared Archive by the same or another user may be presented as a recommendation. This arrangement may allow users to share or serendipitously discover each other's relevant previously saved annotated or unannotated electronic documents through the Shared Archive.

In an embodiment, an online information repository or an online information service may be used as an external data source from which to provide a recommendation. The online information repository or service may be one of a search engine, a document repository, an electronic encyclopedia (such as WIKIPEDIA), an electronic reference, an information feed (such as a news feed, an RSS feed, and the like), a social networking service, and the like. Examples of the foregoing include, but are not limited to: CIA WORLD FACT BOOK, YAHOO! Web Results and News Stories, GOOGLE NEWS, CNN news feed, YAHOO! BOSS, DEL.ICIO.US, FACEBOOK, MYSPACE, STUMBLEUPON, EVERNOTE, and the like. The online information repository or service may be locally or remotely stored, locally or remotely indexed or locally or remotely accessed such as via an application programming interface (API).

Further in the embodiment, a Suggestion Framework may generate a query for an external data source. The query may perform a search against an index or database, retrieve a data feed, and the like, based on a search criteria generated from a user's annotation, annotation selection, annotated electronic document, and the like.

Further in the embodiment, a data source may be processed, established, stored, indexed, queried, maintained, managed, and the like, using any search engine, informational retrieval (IR) or language modeling method, system, framework or technology. As an example, and not a limitation, the search engine may be one of LUCENE, INDRI, NUTCH, SOLR, GOOGLE, YAHOO!, BING, ASK and the like. The search engine, information retrieval (IR) or language modeling method system, framework or technology may support a plurality of methods for measuring the similarity and relevance of documents, producing a recommendation, ranking recommendations, and the like. Further in the embodiment, the data source may be processed, established, stored, indexed, queried, maintained, managed, and the like, using any distributed storage, file or computing method, system, framework or technology. As an example, and not a limitation, the distributed computing framework may be one of HADOOP, MAPREDUCE, and the like; and the distributed file system may be one of GOOGLE FILE SYSTEM and the like.

In an embodiment, a natural language processing method, system, framework or technology may be used to identify and extract terms from an electronic document. As an example, and not a limitation, the OPENCALAIS Web service from THOMPSON REUTERS may be used as a natural language processor. The natural language processing method, system, framework or technology may be used for named entity recognition (NER) to identify entity types, persons, and the like.

The Recommendation System may utilize a web service to maintain scalability or to increase capacity, throughput, and speed. As an example, and not a limitation, the web service may be one of the AMAZON WEB SERVICES (AWS), GOOGLE APP ENGINE, and the like.

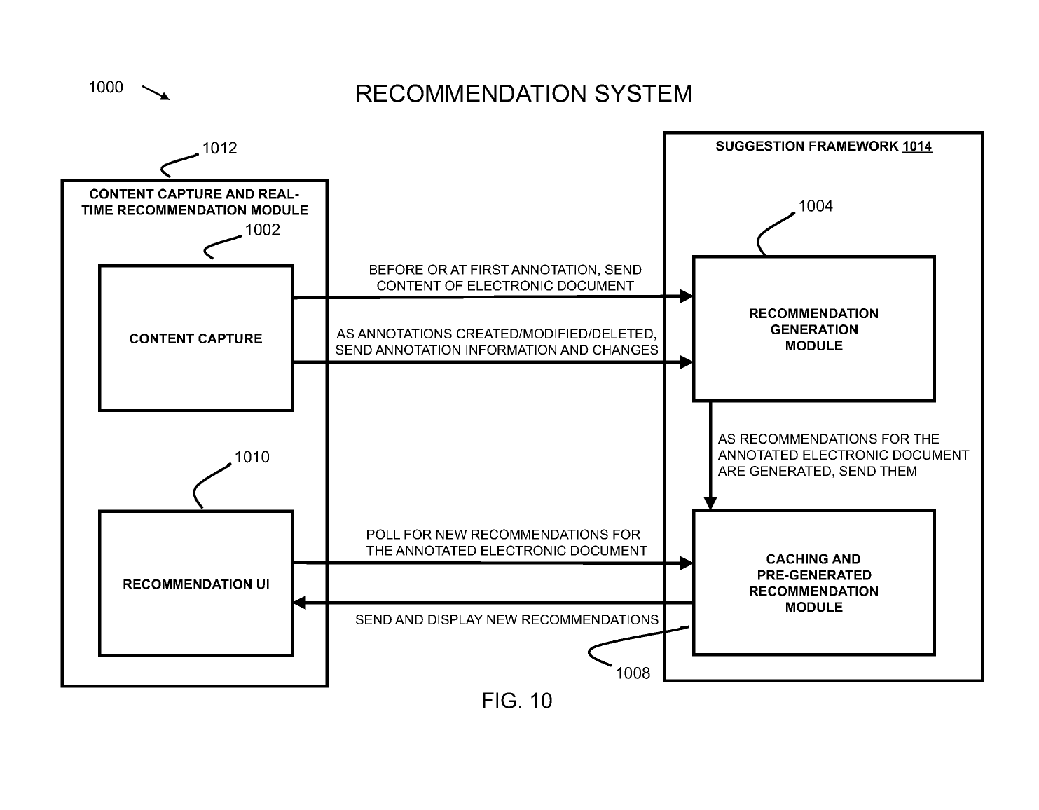

Referring to FIG. 10, a Suggestion Framework 1014 may consist of a plurality of modules, including a Recommendation Generation module 1004 and a Caching and Pre-Generated Recommendation module 1008. In an embodiment, a Content Capture and Real-Time Recommendation module 1012 may capture 1002 in real time the content and state of an electronic document and annotations to it. Further in the embodiment, the Content Capture and Real-Time Recommendation module 1012 may provide and display a recommendation to the user in real-time through a Recommendation System UI 1010 while the user is viewing and annotating an electronic document. A user may use any known or not yet known digital annotation tools to annotate an electronic document. Before annotation or at first annotation, the content of the electronic document may be sent to a recommendation generation module 1004. As annotations are created, modified, deleted, and the like, annotation information and changes may be sent to the recommendation generation module 1004.

A Recommendation Generation module 1004 of a Suggestion Framework 1014 may use the content captured 1002 by the Content Capture and Real-Time Recommendation module 1012 to generate a recommendation. As recommendations for the annotated electronic document are generated, they may be sent from the Recommendation Generation module 1004 to the Content Capture and Real-Time Recommendation module 1012. The Caching and Pre-Generated Recommendation module 1008 may cache in a storage medium the data generated by the Recommendation Generation module 1004. Further in the embodiment, the Caching and Pre-Generated Recommendation module may provide a recommendation to a user alongside a Personal or Shared Archive. The Content Capture and Real-Time Recommendation module 1012 may poll for new recommendations and deliver them to a Recommendation System UI module 1010. In an embodiment, the Recommendation System UI module 1010 may conduct the polling directly.”

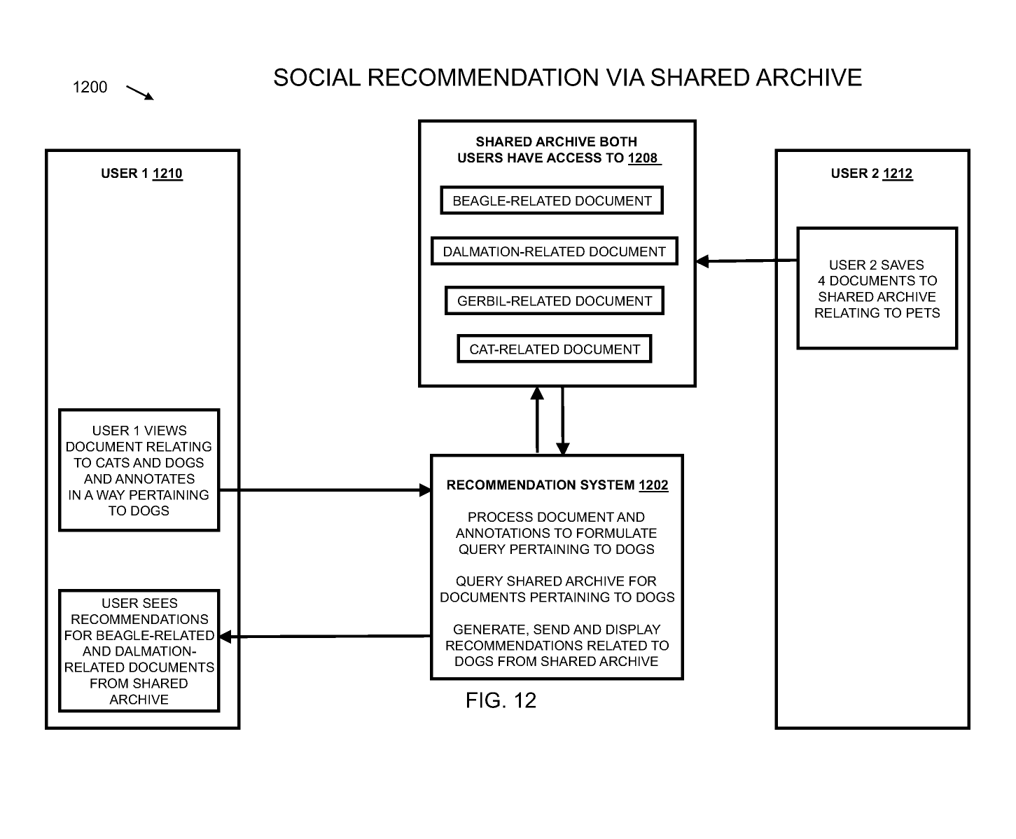

In an embodiment of the recommendation system, access to a shared repository may enable the recommendation system to deliver social recommendations. A Social Recommendation module of the Recommendation System 1202 may process and index previously stored electronic documents in a Shared Archive 1208 to allow for a recommendation to be created from the Shared Archive. FIG. 12 depicts a process flow of an example of a social recommendation being generated by the Recommendation System 1202. In the example, user 1 1210 may view a document relating to cats and dogs and annotate in a way pertaining to dogs. The document and annotations may be submitted to the Recommendation System 1202 where they are processed to formulate a query relating to dogs. User 2 1212 may have previously saved documents to a Shared Archive 1208 relating to pets, such as a beagle-related document, a dalmation-related document, a gerbil-related document, and a cat-related document. The Recommendation System 1202 may query the Shared Archive 1208 for documents relating to dogs and may generate as recommendations any identified documents related to dogs, such as the beagle-related and dalmation-related documents. The Recommendation System 1202 may send and display such recommendations to user 1 1210.

In an embodiment, the Content Capture and Real-Time Recommendation module 1012 may dynamically capture the user annotation and full content of an electronic document in order to provide a broader context for annotations on the electronic document.

The Content Capture and Real-Time Recommendation module 1012 may capture content by an abstraction of the state of the electronic document and annotation (a SuggestionSession). The SuggestionSession may represent the electronic document and annotation through a plurality of scenarios, including, but not limited to, annotating an electronic document before it had been saved and annotating a previously annotated and saved electronic document. The SuggestionSession may store the full HTML content of an electronic Web document or web page, along with other electronic document details, such as a page title, URL, and the like. Further in the embodiment, the SuggestionSession may contain an annotation of the electronic document, and information related to the annotation.

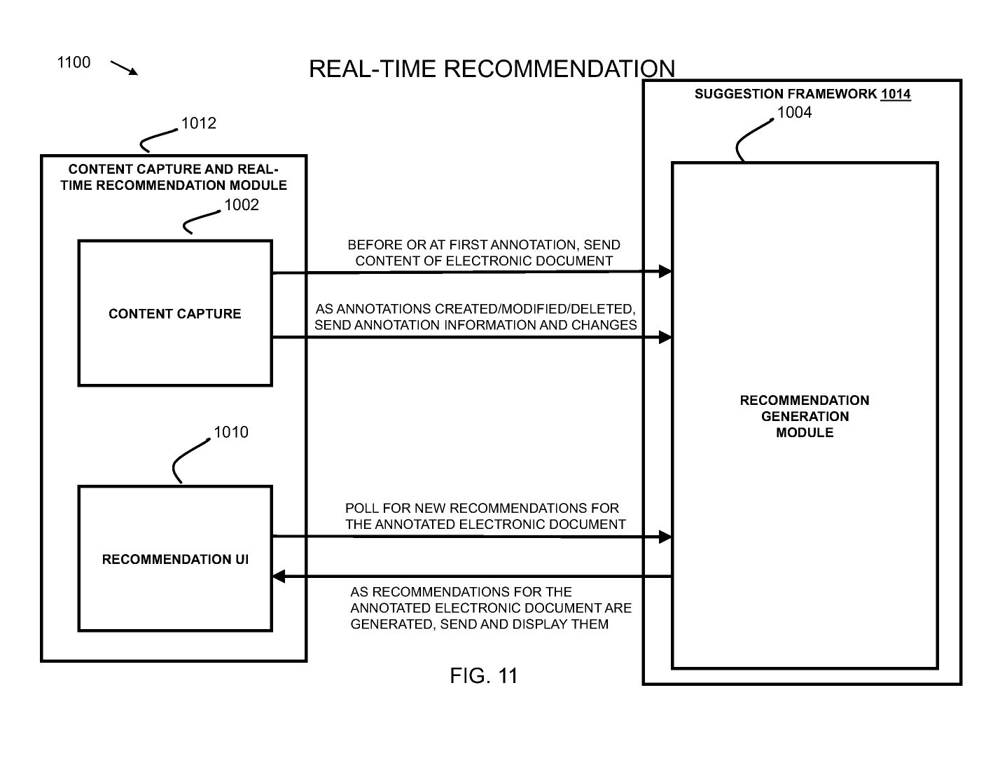

In an embodiment, the SuggestionSession may provide real-time recommendation to a user while the user annotates an electronic document. Further in the embodiment, the SuggestionSession may reside on a server and may need to synchronize information between the server and the user's Internet browser or other application displaying the electronic document being annotated. An API may be utilized to allow the Toolbar, plug-in, add-on, extension, bookmarklet, widget, app, JavaScript-based toolbar, or the like, to communicate a change made by the user to an electronic document to the server. The user change may be the addition, modification, or deletion of an annotation. Further in the embodiment, in order to reduce wait times, the server may return a recommendation representing a partial search result in response to an update from the Toolbar, plug-in, add-on, extension, bookmarklet, widget, app, JavaScript-based toolbar or the like. The Toolbar, plug-in, add-on, extension, bookmarklet, widget, app, JavaScript-based toolbar or the like may periodically poll the server for an additional recommendation. The server may periodically send, or push, an additional recommendation to the Toolbar, plug-in, add-on, extension, bookmarklet, widget, app, JavaScript-based toolbar or the like with or without it polling the server for it. In the case of real-time recommendations, and also referring to FIG. 11, the Caching and Pre-Generated Recommendation module 1008 may be optional such that recommendations generated by the Recommendation Generation module 1004 may be sent directly to and displayed in the Recommendation UI 1010.

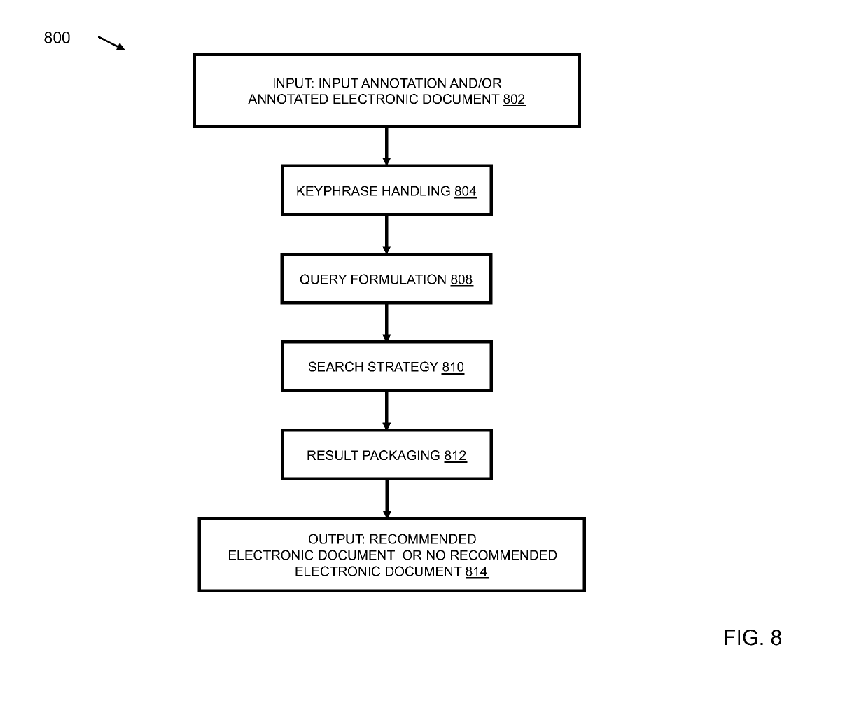

Referring now to FIG. 8, the Recommendation Generation module 1004 may generate a recommendation from a plurality of data sources based on content captured 1002 by the Content Capture and Real-Time Recommendation module 1012. The Recommendation Generation module may perform a plurality of steps in any order, including, but not limited to: keyphrase handling 804, including keyphrase extraction, keyphrase filtering, and keyphrase boosting; query formulation 808; search strategy 810; and result packaging 812, wherein the input is an annotation and/or annotated electronic document 802 and the output is a recommended electronic document or no recommended electronic documents 814.

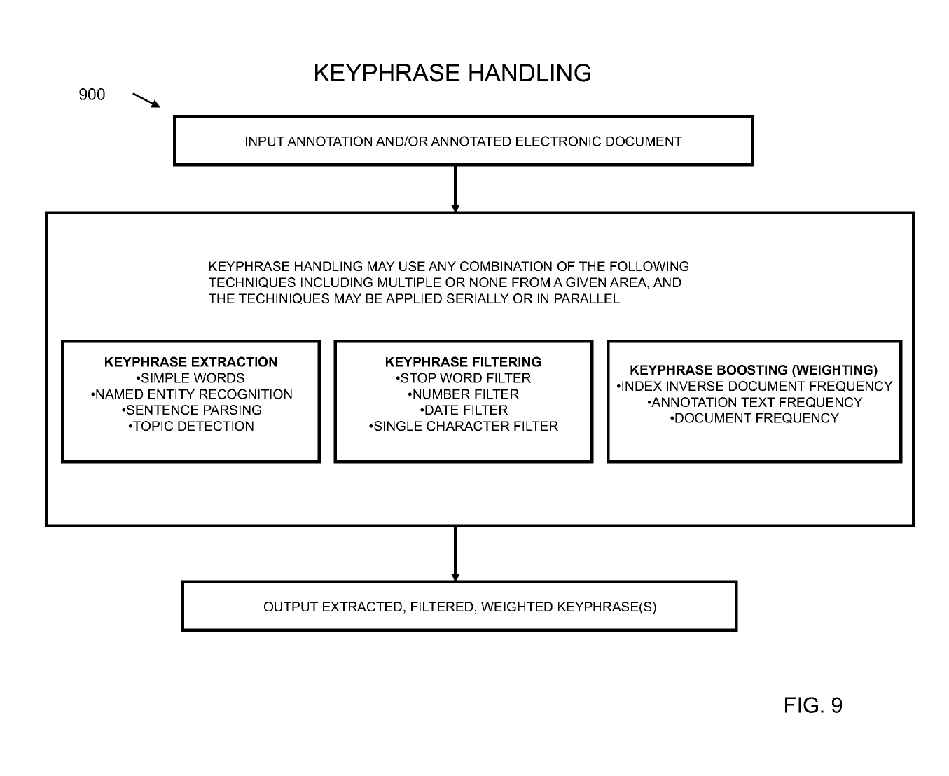

Referring to FIG. 9, a process flow for keyphrase handling is depicted, wherein the input is an annotation and/or annotated electronic document and the output is one or more weighted keyphrases. Keyphrase handling may use any combination of keyphrase extraction, keyphrase filtering, and keyphrase boosting or weighting techniques, including multiple or none from a given area, and the techniques may be applied serially or in parallel.

During the Keyphrase Extraction step, the Recommendation Generation module may extract a keyphrase from the text of an annotation and/or electronic document, using simple words, named entity recognition, sentence parsing, and the like.

During the Keyphrase Filtering step, the Recommendation Generation module may use a plurality of techniques to filter a plurality of extracted keyphrases to remove undesirable keyphrases and produce a subset of filtered keyphrases that are desirable. The filter techniques which may be used include a stop words filter, a number filter, a date filter, a single character filter, and the like.

Desirable keyphrases may be those that are relevant to the content, the user's interests, information needs, demographics, membership in a group or project, geography, occupation, and the like. A weight may be assigned to each desirable filtered keyphrase that may rate the keyphrase's relevance, significance, value, or the like.

During the Keyphrase Boosting step, the Recommendation Generation module may adjust a desirable filtered keyphrase's weight. A plurality of strategies may be employed for adjusting or manipulating a keyphrase weight, including boosting or weighting based on index inverse document frequency (IDF), annotation text frequency, document frequency, and the like. An example of a strategy, and not a limitation, may be increasing the relevance weight of any keyphrase related to a particular product that the user is shopping for and reading about in the electronic document.

During the Query Formulation step, the Recommendation Generation module may create a search query from a plurality of weighted keyphrases.

During the Search Strategy step, the Recommendation Generation module may accept a search query for evaluation by a retrieval system and against a data source, wherein the data source may be at least one of remotely accessed (such as via an application programming interface (API)), locally accessed, remotely indexed, locally indexed, remotely stored or locally stored. The module may produce a recommendation as the result of a search of a data source.

During the Result Packaging step, the Recommendation Generation module may adjust cosmetic details of a recommendation. As an example, and not a limitation, the title, URL, content snippet, and the like may be modified for proper presentation to the user. In an embodiment, a plurality of data sources may each have an independent result packaging step associated with them. The result packaging step may produce different results depending on the type of the data source, the type of the data in the data source, the desired format of the data, the user's profile, and the like. In an embodiment, a plurality of templates may be created to package results from a plurality of data sources, with each template being applied to a data source that fits particular criteria.

In an embodiment, the Recommendation Generation module may make a call to a third party Web service. A Caching and Pre-Generated Recommendation module may be used to alleviate a delay associated with round-trip communication with a third party Web service or an internal processing delay. Furthermore, a third party Web service may limit the number of calls that it will process within a given timeframe. The Caching and Pre-Generated Recommendation module may reduce the number of calls made to a third party Web service by caching the requests and responses, thereby reducing the need to resend requests. Further in the embodiment, data returned by a third party Web service may be stored and identified with a SuggestionSession. A subsequent call to retrieve the data may not require a call to the third party Web service; the locally stored copy may be used instead.

In another embodiment, the Caching and Pre-Generated Recommendation module may store a pre-generated recommendation for presentation in the Suggestions Box alongside a user's Personal Archive or Shared Archive (FIG. 3). The first time a user may visit an electronic document and create an annotation, the subsequently generated recommendation may be stored by the Caching and Pre-Generated Recommendation module (FIG. 10). If the user stores the electronic document in the user's Personal or Shared Archive, a recommendation for that page may be generated and put into cache. Further in the embodiment, a user may navigate through the Personal or Shared Archive to a particular electronic document, and the previously stored recommendation may be retrieved and displayed in a Suggestions Box (FIG. 3).

A Social Recommendation module may enable recommendation of a saved electronic document from a Shared Archive (FIG. 12). In an embodiment, an electronic document transferred into a Shared Archive may be parsed, and its text may be extracted from other content. In an embodiment, the electronic document may be a web page and the other content may be HTML content. Further in the embodiment, the text may be pushed into a search index. As an example, and not a limitation, a search index may be a LUCENE index. The entry for the electronic document in the index may contain a field with the ID of the Shared Archive containing the electronic document.

In an embodiment, a Suggester may be used for testing and evaluation of specific search strategies for each data source. A Suggester may contain a particular approach to the various processing stages under the Recommendation Generation module. The various processing stages may be tailored to the unique opportunities and limitations presented by each data source. Each resulting Suggester may generate results that may be presented to a user via the Suggestions Box. As an example, and not a limitation, specific Suggesters that may be implemented are described in Table 1.

TABLE 1
Specific Implemented Suggesters
Suggester

WIKIPEDIA LUCENE
WIKIPEDIA INDRI
Electronic Documents in a Shared Archive
DEL.ICIO.US
YAHOO! Web
YAHOO! News
CIA WORLD FACTBOOK

A log file may be used to enable effective investigation of Recommendation System results and failures. The log file may be created each time a recommendation is generated. In an embodiment, the logging capability may be built on top of the Apache Log4J project using a special topic for each run of the Suggestion Framework and a custom formatter that generates HTML output to enable viewing of the log file online. The log file may enable viewing of the input and output of the Suggestion Framework's modules, including specific implemented Suggesters. The log may be viewed to troubleshoot a recommendation that either seemed to be of low relevance or failed to appear due to a System bug or other failure. In another embodiment, a permanent link to the log file may be created to aid in investigation of a problem.

In an embodiment, the Recommendation System may contain an Evaluation Facility. The Evaluation Facility may present a user with a scoring control that may enable the user to score or rate a recommendation presented during normal use of the Recommendation System. In an embodiment, the scoring control may be implemented as “thumbs up” and “thumbs down” icons added to each recommendation in the Suggestions Box that appear while a user annotates an electronic document (FIG. 5). A user may click these icons to make a relevance assessment of Irrelevant (thumbs down) or Relevant (thumbs up). In an embodiment, the user's selection may be saved to the server with a unique identifier for the associated recommendation. Further in the embodiment, a user's decision to view a particular recommendation may also be saved to the server.

In an embodiment, the Evaluation Facility may provide a means for the Recommendation System to continuously improve the quality of recommendations. A user's scoring of a recommendation, combined with previous scoring of other recommendations may be used to generate a user profile. The Evaluation Facility may be able to generate a pattern of relevance for each user who marks recommendations as relevant and irrelevant. The pattern of relevance may be stored in the user profile, and may be used in generating a future recommendation, which may have improved relevance.

In another embodiment, the Evaluation Facility may provide a means for the Recommendation System to provide a more useful recommendation based on a Shared Archive. A user's recommendation scoring may be used to analyze which recommendations from a Shared Archive a user finds to be more relevant, and a user profile may be created. In a future search, a user may be shown only recommendations that match the user profile.

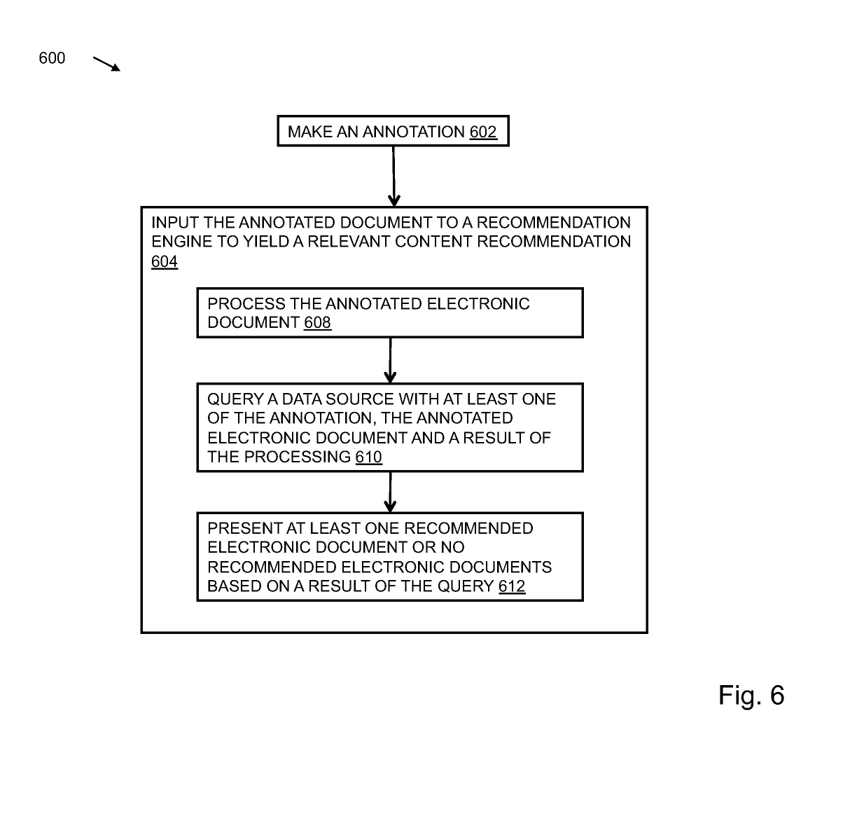

Referring to FIG. 6, in an aspect of the invention, a method for recommending content may include making an annotation 602 to an electronic document and inputting the annotation to a recommendation engine to yield a relevant content recommendation 604. Inputting may involve processing the annotated electronic document 608, querying a data source with at least one of the annotation, the annotated electronic document and a result of the processing 610, and presenting at least one of at least one recommended electronic document or no recommended electronic documents based on a result of the query 612. The method may be embodied in a computer readable medium that when executing on one or more processors performs one or more of steps 602, 604, 608, 610, and 612. Processing may involve extracting at least one keyphrase. Processing may further involve one or more of filtering the keyphrase to remove an undesirable keyphrase and adjusting a weight of the keyphrase to obtain at least one weighted keyphrase. The annotation, the at least one keyphrase, and/or the annotated electronic document may be weighted in the input to the recommendation engine. The data source may be at least one of a repository of electronic documents, a database of data, a repository of information, a shared repository of a plurality of electronic documents, wherein at least one of the plurality of electronic documents is optionally annotated, and a plurality of a second user's or group of users' electronic documents. The data source may be at least one of remotely accessed (such as via an application programming interface (API)), locally accessed, remotely indexed, locally indexed, remotely stored or locally stored. The electronic document, which may be any of the annotated electronic documents, queried electronic documents, second user's or group of users' electronic documents, recommended electronic documents, or the like, may be at least one of a web page, an HTML page, an HTML document, a Flash-based document, a Word document, a Powerpoint presentation, an Excel spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

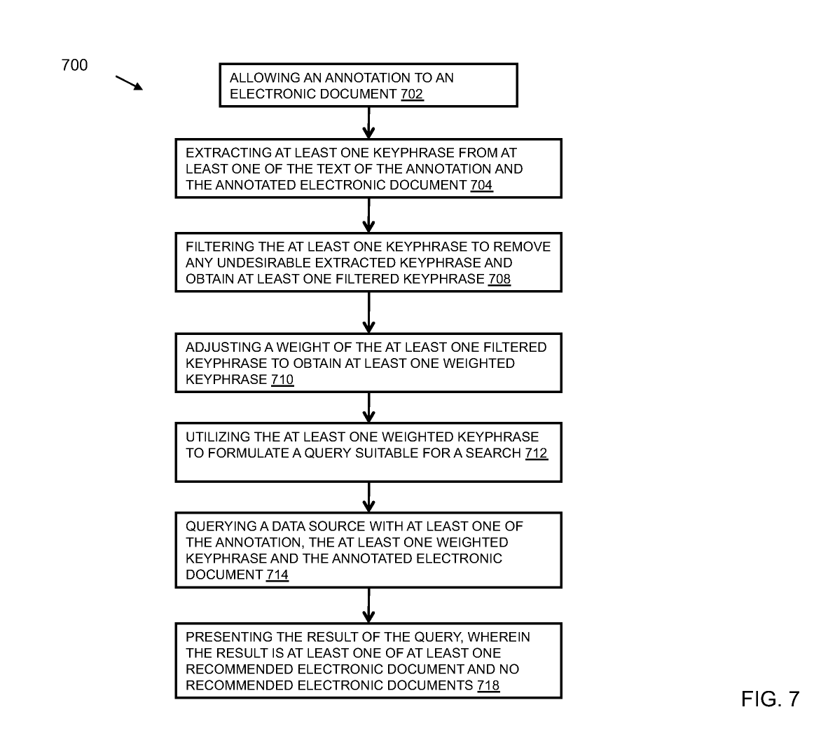

Referring to FIG. 7, in an aspect of the invention, a method may include allowing an annotation to an electronic document 702, extracting at least one keyphrase from at least one of the text of the annotation and the annotated electronic document 704, filtering the at least one keyphrase to remove any undesirable extracted keyphrase and obtain at least one filtered keyphrase 708, adjusting a weight of the at least one filtered keyphrase to obtain at least one weighted keyphrase 710, utilizing the at least one weighted keyphrase to formulate a query suitable for a search 712, querying a data source with at least one of the annotation, the at least one weighted keyphrase and the annotated electronic document 714, and presenting the result of the query, wherein the result is at least one of at least one recommended electronic document and no recommended electronic documents 718. In an embodiment, the filtering steps may be optional. In an embodiment, the weighting steps may be optional. The data source may be at least one of a repository of electronic documents, a database of data, a repository of information, a shared repository of a plurality of electronic documents, wherein at least one of the plurality of electronic documents is optionally annotated, and a plurality of a second user's or group of users' electronic documents. The data source may be at least one of remotely accessed (such as via an application programming interface (API)), locally accessed, remotely indexed, locally indexed, remotely stored or locally stored. The electronic document, which may be any of the annotated electronic document, the recommended electronic document, electronic documents in a repository, or any other of the electronic documents described herein, may be at least one of a web page, an HTML page, an HTML document, a Flash-based document, a Word document, a POWERPOINT presentation, an EXCEL spreadsheet, a PDF, a word processing document, an OCR'ed document, a presentation, a spreadsheet, a text document, a rich text document, a Web document, an online document, a GOOGLE DOC, a GOOGLE DOCUMENT, a GOOGLE Spreadsheet, a GOOGLE Presentation, a ZOHO DOC, a ZOHO Document, a ZOHO Spreadsheet, a ZOHO Presentation, an online text document, an online presentation, and an online spreadsheet.

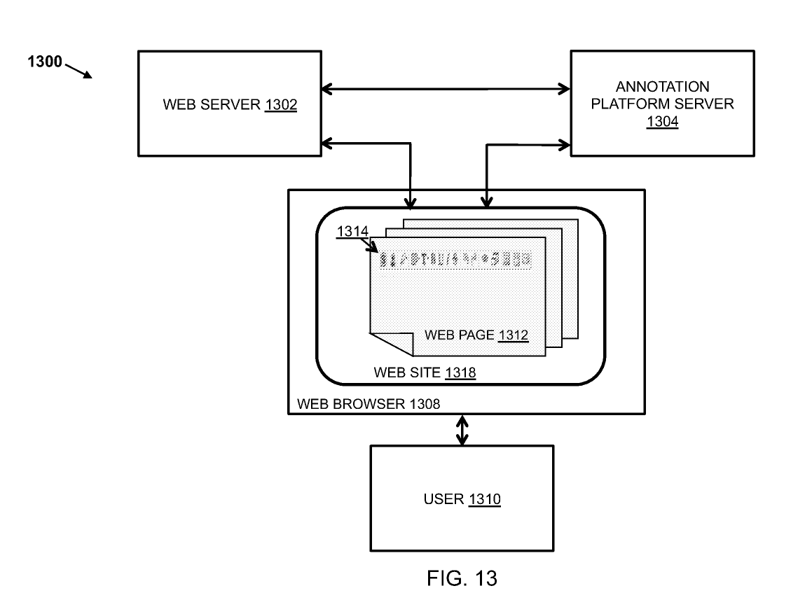

FIG. 13 depicts a system 1300 for embedding a user interface for web page annotation, for annotating web pages and content and for managing annotations and annotated web pages and content, in accordance with an embodiment of the invention. The system 1300 may include a web server 1302, an annotation platform server 1304, a web browser 1308, and a user 1310 accessing the web browser 1308. The web browser 1308 may include a web page 1312 having a user interface 1314. It will be apparent to a person of ordinary skill in the art that the web server 1302 may host a website 1318 and the web page 1312 may be associated with the website 1318. The web site 1318 may have a plurality of web pages including the web page 1312. The user 1310 may view the web page 1312 using the web browser 1308. Further, it may be apparent that the web browser 1308 may be a client that may request the web page 1312 over the Internet or a private network.

In an embodiment, the web server 1302 may be hosted by a publisher of content. The publisher may be a news provider that may distribute news articles in the form of web pages via its web site 1318. In an embodiment of the invention, the publisher may allow secure access to its web site 1318. The user 1310 may be provided with a first login id and a password to access the web site 1318. The publisher may also allow the user 1310 to create an online account or an online storage space that may be accessed using the first login id and the password. In another embodiment of the invention, the user 1310 may access the publisher's web site 1318 without logging in.

In the embodiment, when the publisher provides a secure access to its web site 1318, the web server 1302 authenticates the first login id and the password of the user 1310. After the authentication is successful, the web server 1302 may provide access to various web pages of the web site 1318 including the web page 1312. In an embodiment of the invention, to enhance the reading experience of the user 1310, the publisher may embed a user interface 1314 or a code corresponding to the user interface 1314 in the web site 1318 such that the web page 1312 includes an embedded user interface 1314 when the web page 1312 is presented to the user 1310. In another embodiment of the invention, the publisher may install a plugin for the user interface 1314 in the web site 1318. In embodiments of the invention, the user interface 1314 may be, without limitations, an annotation tool button, an annotation toolbar including multiple annotation tool buttons, a link to an additional portion of to the user interface, and a button for the user interface. In another embodiment of the invention, the publisher may embed a link or a button in the web site 1318 that, when clicked, may insert, inject, uncover or expand the user interface 1314 in the web page 1312 such that the user interface 1314 does not cover the content displayed on the web page 1312. In yet another embodiment of the invention, the publisher may embed a link or a button in the web site 1318 that, when clicked, may load, a Bookmarklet or Javascript version of the user interface 1314 in the web site 1318 or on the web page 1312 such that the user interface 1314 floats over the web page 1312.

Further in an embodiment of the invention, the user interface 1314 provided by the publisher may be specific to the publisher and may include proprietary annotation tools, annotation tool buttons or annotation toolbar features. In another embodiment of the invention, part or all of the user interface 1314 may be from a third party and may include the third party's proprietary annotation tools, annotation tool buttons or annotation toolbar features. In an example, the third party may be SCRIBLE™. Further, the user interface 1314 may allow the user 1310 to perform various types of annotations by providing tools, without any limitation, for highlighting, adding a note, changing text color, bolding, underlining, italicizing, striking through, undoing an annotation, redoing an annotation, showing all annotations, hiding all annotations, annotating with recorded voice commenting, printing, reading annotations, stamping, boxing, clouding, drawing, circling, marking, calling-out and the like.

In the embodiment when the user interface 1314 is the annotation toolbar with multiple annotation tool buttons, the user 1310 may use the multiple annotation tool buttons of the annotation toolbar to perform various types of annotations on the web page 1312. Also, it will be apparent to a person of ordinary skill in the art that the web page 1312 may take any form of an online web page known in the art like, without limitations, an HyperText Markup Language (HTML) page, an HTML document, a Flash-based document, a web document, an online document, an online text document, an online presentation, an online spreadsheet and the like. Thus, the user 1310 may use any of the multiple annotation tool buttons for working with multiple annotations of content on the web page 1312. In embodiments, the content that may be annotated may include, without limitations, HTML content, an HTML document, Flash-based content, an object, an image, a PDF document, an online text document, an online presentation, an online spreadsheet and the like. In other embodiments, the content is syndicated content.

In an embodiment of the invention, after the user 1310 has annotated the content on the web page 1312 and is logged into the online account, the user 1310 may manage the annotated content, the one or more annotations, and the plurality of web pages including the web page 1312 with the one or more annotations by saving the annotated content, the one or more annotations, and the web page 1312 in a repository on the annotation platform server 1304. Hereinafter, the annotated content, the one or more annotations, and the plurality of web pages including the web page 1312 will be collectively referred to as annotated data. The user interface 1314 may provide a button for saving the annotated data. The user interface 1314 may act as an interface between the user 1310 and the annotation platform server 1314 to facilitate saving of the annotated data in the repository.

In an embodiment of the invention, when the user interface 1314 is provided by a third party, the repository on the annotation platform server 1304 may be provided by the third party to the publisher of the web site 1318. The user 1310 may save the annotated data while being logged into the online account accessed by the first username and password valid for the publisher's web site 1318. In another embodiment of the invention, when the user interface 1314 is provided by a third party, the user 1310 may save the annotated data into the repository by logging into an online account on the third party's annotation platform server 1304. A second login id and password may be required to access the online account on the third party's annotation platform server 1304.

In yet another embodiment of the invention, the repository may be white labeled and thus may be publisher-branded when the user interface 1314 is provided by the third party. The publisher branded repository may be powered by a third party's annotation platform server. In an embodiment of the invention, when the user interface 1314 is provided by the publisher, the user 1310 may save the annotated data in a repository provided by a third party. In another embodiment of the invention, when the user interface 1314 is provided by the publisher, the user 1310 may save the annotated data in a repository provided by the publisher. In various examples of all the embodiments of the repository, the third party may be SCRIBLE™. Further, in various embodiments, the repository may be, without limitations, a user account, a library, an archive, a locker, a briefcase, a folder, network drive and the like. Also, it will be apparent to a person of ordinary skill in the art that the repository on the annotation platform server 1304 may be owned by the publisher or the third party, licensed by the publisher or the third party, rented by the publisher or the third party, maintained by the publisher or the third party, located in the premises of the publisher or the third party, located in a cloud or located in a private network of the publisher or the third party.

In another embodiment of the invention, after the user 1310 has annotated the content on the web page 1312 and is logged into the online account, the user 1310 may manage the annotated data by organizing the annotated data. The user 1310 may retrieve the saved annotated data from the repository on the annotation platform server 1304 and may organize the annotated data. In an embodiment of the invention, the user interface 1314 may provide a button to access the repository in which the annotated data has been stored. In an embodiment of the invention, the user 1310 may organize the retrieved annotated data by allowing at least one of using folders, tags, filters, search, tables, lists, sortable columns, date stamps, time stamps, indices, and structuring the annotated data. The user 1310 may further annotate the retrieved annotated data.

In yet another embodiment of the invention, after the user 1310 has annotated the content on the web page 1312 and is logged into an online account, the user 1310 may manage the annotated data by collaborating on the annotated data with the one or more annotations.

In yet another embodiment of the invention, after the user 1310 has annotated the content on the web page 1312 and is logged into an online account, the user 1310 may manage the annotated data by sharing the annotated data with others.

Further in embodiments of the invention, the user interface 1314 may be configured to be customized. In embodiments, the publisher may customize the user interface 1314 when the user interface 1314 is publisher's proprietary user interface. The user interface 1314 may be customized by selecting one or more annotation tools or annotation tool buttons to be included in the user interface 1314 or in an annotation toolbar. In embodiments when the user interface 1314 is third party's proprietary user interface, the third party may customize the user interface 1314 to include publisher's logo or other preferred branding or message on the user interface 1314.

In an embodiment of the invention, the publisher may embed the user interface 1314 in the web site to syndicate the user interface 1314 along with the content syndicated by the publisher. It will be apparent to a person of ordinary skill in the art that any known technique of syndicating the user interface 1314 may be employed by the invention without deviating from the scope of the invention.

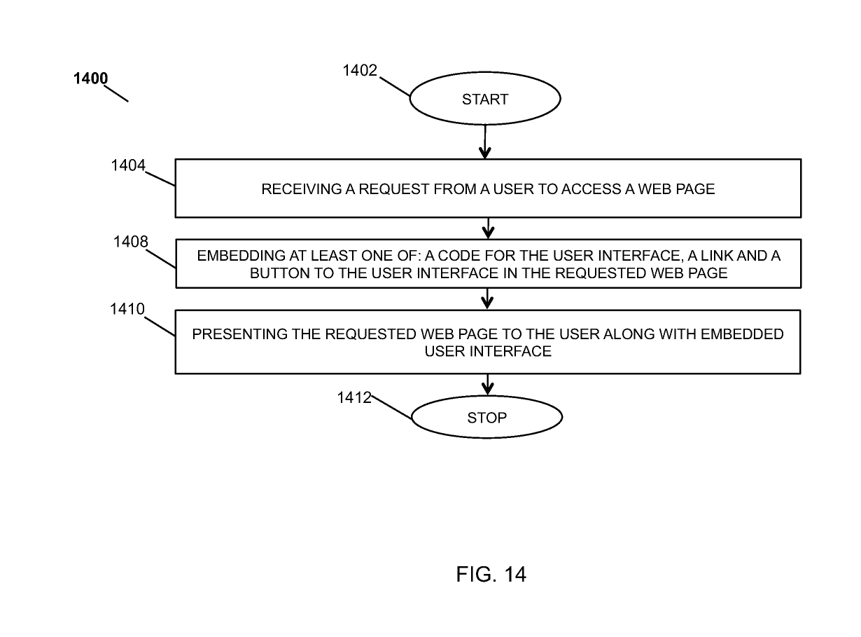

FIG. 14 depicts an exemplary method 1400 for embedding a user interface in a web site, in accordance with an embodiment of the invention. The method initiates at step 1402. At step 1404, a request may be received from a user for displaying a web page associated with a web site hosted at a web server. In examples, the user, the web page, the web site and the web server may be similar to the user 1310, the web page 1312, the web site 1308 and the web server 1302 explained in conjunction with FIG. 13. After the request has been received at step 1408, at least one of a code for the user interface, a link to an additional portion of to the user interface and a button for the user interface may be embedded in the requested web page. Thereafter, at step 1410, the requested web page along with the embedded user interface may be presented to the user. In embodiments, the user interface may be at least one of: an annotation tool button, an annotation toolbar, a link to an additional portion of to the user interface, and a button for the user interface. The method terminates at step 1412.

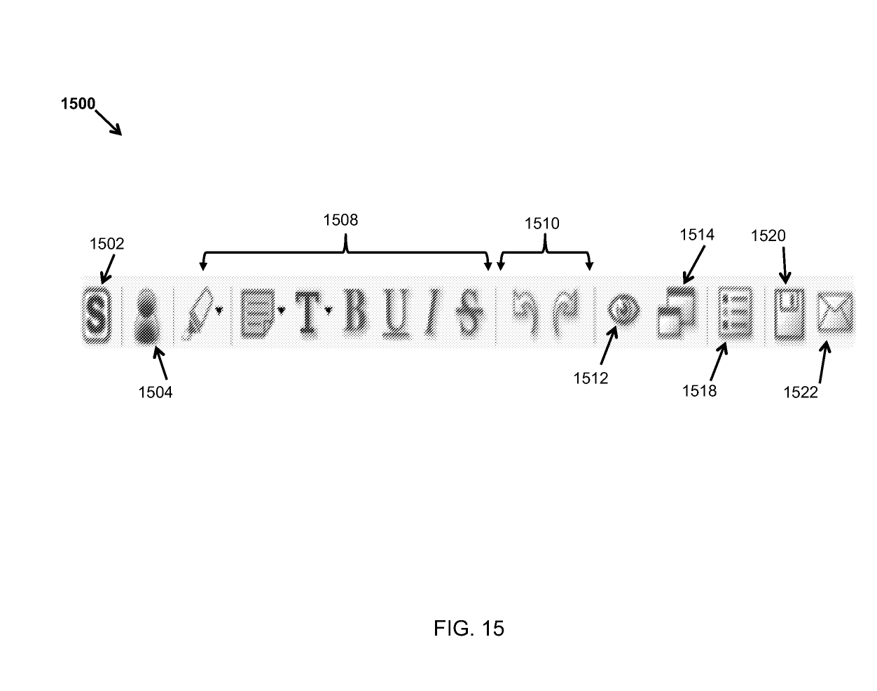

FIG. 15 depicts an exemplary user interface 1500, in accordance with an embodiment of the invention. The user interface 1500 as depicted in FIG. 15 is an annotation toolbar as discussed in conjunction with FIG. 13. In an example, the user interface 1500 may be a white-labeled annotation toolbar and may allow toolbar provider's branding. The user interface 1500 may provide a plurality of buttons that may allow a user to perform various types of annotations and manage the annotated data. In embodiments the user interface 1500 may include a button 1502 for displaying the brand of the user interface's 1500 provider. A button 1504 may allow the user of the user interface 1500 to log into the online account that may be provided by either a publisher or a third party. A plurality of buttons 1508 may facilitate various types of annotations, including content highlighting, adding notes, changing text color and font (bolding, underlining, italicizing, circling, marking etc.), and striking through text. For undoing and redoing annotations, the buttons 1510 may be used. Further, to hide and show all the annotations and legends on a web page, the user may use button 1512 and 1518 respectively. A button 1514 may facilitate minimizing and maximizing all the notes on the web page. Buttons 1520 and 1522 may allow the user to manage the annotated data. The button 1522 may facilitate sharing of the annotated data with other users. In an example, the sharing of annotated data may be achieved though, without any limitation, email. The button 1520 may allow saving the annotated data to an online account provided by the publisher or the third party. In embodiments, the user interface 1500 may have additional buttons (not shown in FIG. 15) that may facilitate access to an online library associated with the online account and store the annotated data, and may facilitate reporting errors and feedback to the publisher or the third party regarding the user interface 1500. It will be apparent to a person of ordinary skill in the art that the user interface 1500 depicted in the FIG. 15 is merely for the illustration purpose and may have any shape, size, layout and may have any number of buttons for facilitating different types of annotations and for the managing of the annotated data.

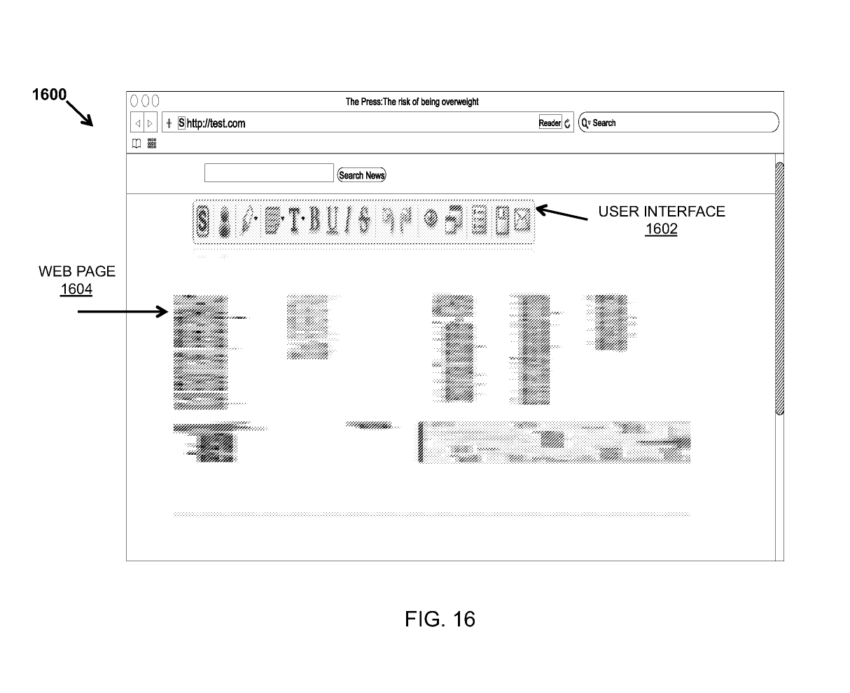

FIG. 16 depicts an exemplary web site 1600 with a user interface 1602 embedded in the web site 1600, in accordance with an embodiment of the invention. The exemplary web site 1600, a web page 1604 and the user interface 1602 as depicted in FIG. 16 are similar to the web site 1318, the web page 1312 and the user interface 1314 explained in conjunction with FIG. 13.

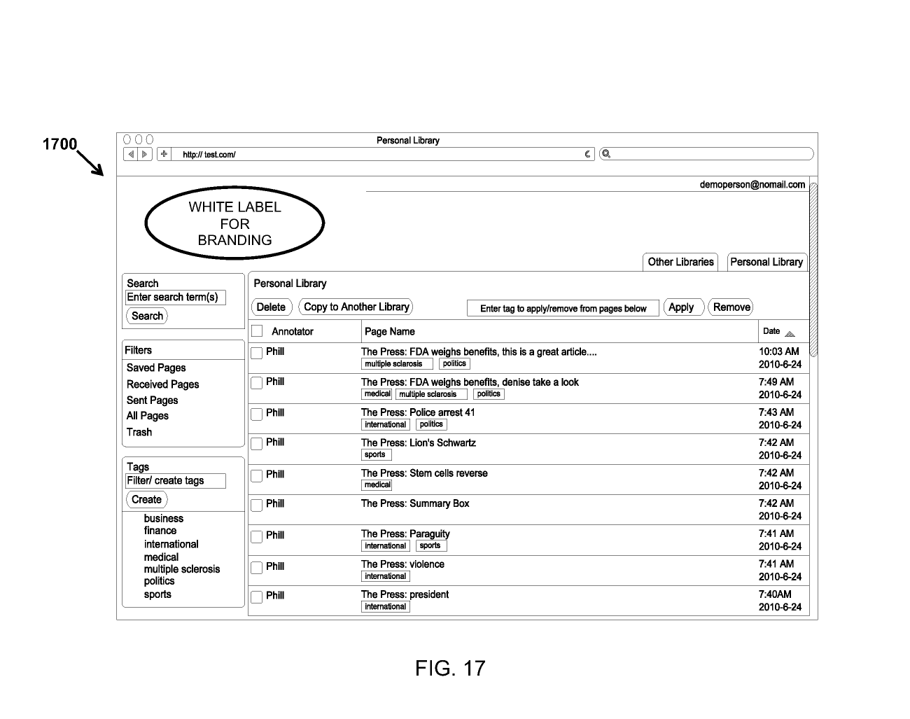

FIG. 17 depicts an exemplary web page 1700 of an exemplary web site for managing annotated content, in accordance with an embodiment of the invention. In an embodiment of the invention, a user (similar to the user 1310) may access the web page 1700 by clicking on a button provided by a user interface similar to the user interface 1314. The web page 1700 may act as an interface for the user to access his/her personal library where the user has stored the annotated data. The web page 1700 may further act as an interface for the user to access other libraries to which the user has access. The web page 1700 may provide a search interface for searching the annotated data. The web page 1700 may provide multiple filters to the user to view the desired annotated data from the stored annotated data. In embodiments, the multiple filters may include, without limitations, saved annotated data, annotated data received from other users, annotated data sent to the other users, all the annotated data, annotated data in a trash, and the like. The web page 1700 may further allow the user to organize the annotated data. In an embodiment of the invention, the web page 1700 may allow tagging of the saved annotated data. The web page 1700 may allow the user to create different tags based on personal choice and requirements. In examples, the tags may be, without limitations, business, finance, international, medical, politics, sports, and the like. The user may further use the tags to filter the annotated data. Further, the web page 1700 may present the annotated data to the user along with the contextual information associated with the annotated data. In embodiments, the contextual information may include, without limitations, name of the annotator, name of the annotated web page, date & time associated with the annotation or web page, and the like. In embodiments, the web page 1700 may be white-labeled for branding. It will be apparent to a person of ordinary skill in the art that the web page 1700 has been depicted only for the illustration purpose and may take any known in the art layout and presentation style.

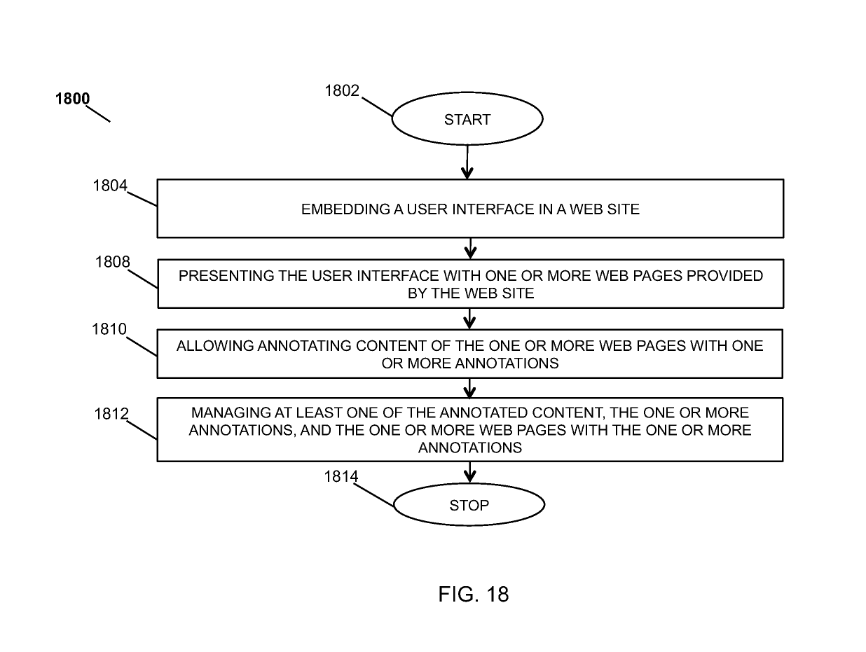

FIG. 18 illustrates a method 1800 for annotating and managing web pages in connection with a user interface embedded in a web site, in accordance with an embodiment of the present invention. The method 1800 starts at step 1802. At step 1804, a user interface may be embedded in a web site. The user interface may include at least one annotation tool. Further, embedding the user interface may include at least one of embedding a code for the user interface, embedding a link to the user interface and embedding a button for the user interface. In embodiments, the user interface may be an annotation tool button, an annotation toolbar, a link to an additional portion of to the user interface, a button for the user interface and the like. Further, the user interface may be configured to be customized. The user interface may include customizing by at least one of including one or more annotation tools, branding the user interface and adjusting the color, size, layout and other design elements of the user interface. Further, customizing may include customizing by the website. Furthermore, the at least one annotation tool may include at least one of tools for highlighting, adding a note, changing text color, bolding, underlining, italicizing, striking through, undoing an annotation, redoing an annotation, showing all annotations, hiding all annotations, annotating with recorded voice, commenting, printing, reading annotations, stamping, boxing, clouding, drawing, circling, marking, calling-out, and the like.

At step 1808, the user interface may be presented with one or more web pages provided by the web site. Presentation of the user interface may include presenting the annotation toolbar to one or more authenticated viewers. The authenticated viewers may be authenticated by the web site. Further, at step 1810, annotation of content of one or more web pages may be allowed with one or more annotations. The annotations may be allowed using at least one annotation tool through the user interface. In an embodiment, the content may include at least one of HTML content, an HTML document, Flash-based content, an object, an image, a PDF document, an online text document, an online presentation, an online spreadsheet, and the like. Further, annotated content may be syndicated content and the web site may host syndicated content.

At step 1812 of the method 1800, at least one of the annotated content, the one or more annotations, and the one or more web pages with the one or more annotations may be managed. The managing may include organizing at least one of the annotated content, the one or more annotations, and the one or more web pages with the one or more annotations. Further, the organizing may include at least one of the following: folders, tags, filters, search, tables, lists, sortable columns, date stamps, time stamps, indices, hierarchies, ontologies, data structures, and the like. The organizing may also include further annotating the at least one of the annotated content, the one or more annotations, and the one or more web pages with the one or more annotations.

In embodiments, the managing may further include saving the at least one of the annotated content, the one or more annotations, and the one or more web pages with the one or more annotations. The saving may include saving at a repository of the web site. The saving may further include saving to a cloud, a remote server, an online account or a repository, and the like. In another embodiment, the managing may further include collaborating on the at least one of the annotated content, the one or more annotations, and the one or more web pages with the one or more annotations. Further, in embodiments, the managing may include sharing the at least one of the annotated content, the one or more annotations, and the one or more web pages with the one or more annotations. The method 1800 may further include making at least one recommendation related to the annotating of the one or more web pages. The method 1800 terminates at step 1814.

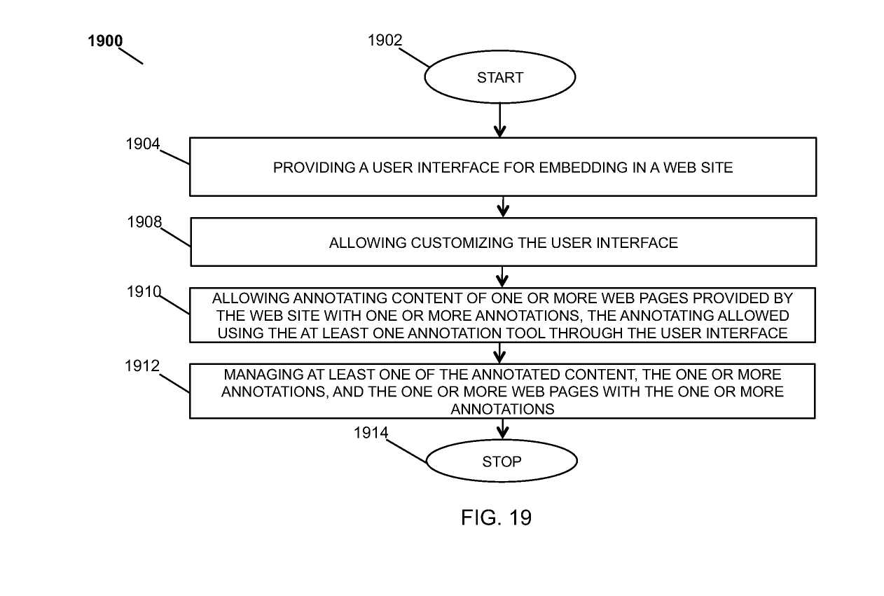

FIG. 19 depicts a method 1900 for annotating and managing web pages in connection with a user interface embedded in a web site, in accordance with another embodiment of the present invention. The method 1900 starts at step 1902. At step 1904, a user interface may be provided for embedding in a web site. The user interface may include at least one of an annotation tool button, an annotation toolbar, a link to an additional portion of the user interface, a button for the user interface and the like. Further, the user interface may be embedded in the form of code for the user interface, a link to an additional portion of the user interface, a button for the user interface, and the like. In an embodiment, the method 1900 may include providing a white-labeled version of the user interface.

Further, at step 1908, customization of the user interface may be allowed. Customizing the user interface may comprise customizing by at least one of including one or more annotation tools, branding the user interface and adjusting the color, size, layout and other design elements of the user interface. The step 1908 may further include customizing the white-labeled version of the user interface.

After the customization of the user interface, at step 1910, the method 1900 may allow annotating content of the one or more web pages with one or more annotations. The annotations may be allowed using the at least one annotation tool through the user interface. The annotation tool may include at least one tool for highlighting, adding a note, changing text color, bolding, underlining, italicizing, striking through, undoing an annotation, redoing an annotation, showing all annotations, hiding all annotations, annotating with recorded voice, commenting, printing, reading annotations, stamping, boxing, clouding, drawing, circling, marking and calling-out. Further, annotated content may be syndicated content and the web site may host syndicated content.

Thereafter, at step 1912, at least one of the annotated content, the one or more annotations, and the one or more web pages with the one or more annotations may be managed. Managing may include organizing at least one of the annotated content, the one or more annotations, and the one or more web pages with the one or more annotations. The organizing may include at least one of the following: folders, tags, filters, search, tables, lists, sortable columns, date stamps, time stamps, indices, hierarchies, ontologies, data structures, and the like. The organizing may also include further annotating the at least one of the annotated content, the one or more annotations, and the one or more web pages with the one or more annotations.

In embodiments, the managing may further include saving the at least one of the annotated content, the one or more annotations, and the one or more web pages with the one or more annotations. The saving may include saving at a repository of a provider of the user interface. The saving may further include saving to a cloud, a remote server or an online account or a repository and the like. Further, the managing may include collaborating on the at least one of the annotated content, the one or more annotations, and one or more web pages with the one or more annotations. The managing may also include sharing the at least one of the annotated content, the one or more annotations, and the one or more web pages with the one or more annotations. The method 1900 may further comprise making at least one recommendation related to the annotating of the one or more web pages. The method 1900 terminates at step 1914.

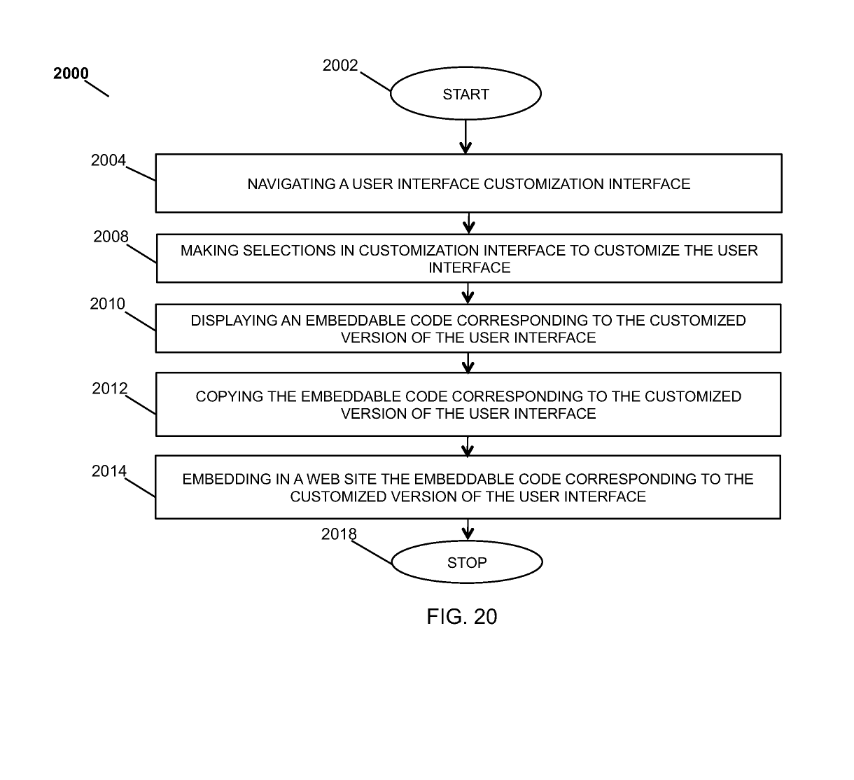

FIG. 20 depicts an exemplary method 2000 for customizing and embedding a user interface, in accordance with an embodiment of the invention. The method 2000 initiates at step 2002. At step 2004, a user interface customization interface is navigated. While navigating the user interface customization interface, at step 2008, selections are made in the customization interface to customize the user interface. Thereafter, at step 2010, an embeddable code corresponding to the customized version of the user interface is displayed. At step 2012, the displayed embeddable code corresponding to the customized version of the user interface is copied. After the code has been copied, at step 2014, the embeddable code corresponding to the customized version of the user interface is embedded in a web site. The method 2000 terminates at step 2018.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The system and each of the methods disclosed herein may be implemented as a part a variety of user interfaces, ranging from hardware interfaces to software applications that include editing functionality; thus, interfaces may include keyboard-based interfaces, touch screens, stylus-based interfaces, wheel-based devices, mouse-based interfaces, cursor-based interfaces, voice-based interfaces, document readers, text-to-voice applications, voice-to-text applications, electronic book readers, scanners, and the like. Interfaces and applications may further include interfaces (such as browsers and application interfaces), programs, and applications on tablet computers (such as IPAD), on e-book readers, such as the AMAZON® KINDLE®, on mobile phones and PDAs (e.g., IPHONE®, BLACKBERRY®, OR PALM® devices), and the like. All such interfaces are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law. All documents referenced herein are hereby incorporated by reference.

What is claimed is:

1. A method comprising:
embedding a user interface in a web site, the user interface comprising at least one annotation tool;
presenting the user interface with one or more web pages provided by the web site;
allowing annotating content of the one or more web pages with one or more annotations, the annotating allowed using the at least one annotation tool through the user interface; and
managing at least one of the annotated content, the one or more annotations, and the one or more web pages with the one or more annotations.

2. The method of claim 1, wherein the embedding comprises at least one of: embedding a code for the user interface, embedding a link to the user interface and embedding a button for the user interface.

3. The method of claim 1, wherein the user interface is one of an annotation tool button, an annotation toolbar, a link to an additional portion of the user interface, and a button for the user interface.

4. The method of claim 3, wherein the user interface is configured to be customized.

5. The method of claim 4, wherein the user interface comprises customizing by at least one of including one or more annotation tools, branding the user interface and adjusting the color, size, layout and other design elements of the user interface.

6. The method of claim 4, wherein the customizing comprises customizing by the web site.

7. The method of claim 1, wherein the web site hosts syndicated content.

8. The method of claim 1, wherein the at least one annotation tool comprises at least one of tools for highlighting, adding a note, changing text color, bolding, underlining, italicizing, striking through, undoing an annotation, redoing an annotation, showing all annotations, hiding all annotations, annotating with recorded voice, commenting, printing, reading annotations, stamping, boxing, clouding, drawing, circling, marking and calling-out.

9. The method of claim 1, wherein the presenting comprises presenting the user interface to one or more authenticated viewers, wherein the authenticated viewers are authenticated by the web site.

10. The method of claim 1, wherein the content comprises at least one of HTML content, an HTML document, Flash-based content, an object, an image, a PDF document, an online text document, an online presentation, and an online spreadsheet.

11. The method of claim 1, wherein the content is syndicated content.

12. The method of claim 1, wherein the managing comprises organizing at least one of the annotated content, the one or more annotations, and the one or more web pages with the one or more annotations.

13. The method of claim 12, wherein the organizing comprises using at least one of folders, tags, filters, search, tables, lists, sortable columns, date stamps, time stamps, indices, hierarchies, ontologies and datastructures.

14. The method of claim 12, wherein the organizing comprises further annotating the at least one of the annotated content, the one or more annotations, and the one or more web pages with the one or more annotations.

15. The method of claim 1, wherein the managing comprises saving the at least one of the annotated content, the one or more annotations, and the one or more web pages with the one or more annotations.

16. The method of claim 15, wherein the saving comprises saving at a repository of the web site.

17. The method of claim 15, wherein the saving comprises at least one of saving to a cloud, a remote server or an online account or a repository.

18. The method of claim 1, wherein the managing comprises collaborating on the at least one of the annotated content, the one or more annotations, and the one or more web pages with the one or more annotations.

19. The method of claim 1, wherein the managing comprises sharing the at least one of the annotated content, the one or more annotations, and the one or more web pages with the one or more annotations.

20. The method of claim 1, wherein the method further comprises making at least one recommendation related to the annotating of the one or more web pages.
